(19) United States
(12) Patent Application Publication
(10) Pub. No.: US 2010/0228683 A1
(43) Pub. Date: Sep. 9, 2010

(54) ISSUING SYSTEMS, ACQUIRING SYSTEMS, AND PAYMENT NETWORKS/SYSTEMS DEVELOPMENT

(75) Inventors: Carl Ansley, New York, NY (US); Anil Datt Aggarwal, New York, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: TxVia, Inc., New York, NY (US)

(21) Appl. No.: 12/718,971

(22) Filed: Mar. 6, 2010

Related U.S. Application Data
(63) Continuation-in-part of application No. 12/703,162, filed on Feb. 9, 2010.
(60) Provisional application No. 61/158,259, filed on Mar. 6, 2009.

(51) Int. Cl. G06Q 40/00; G06Q 10/00; G10L 15/00; G06F 3/048; G06F 9/44

(52) U.S. Cl. 705/348; 704/246; 715/771; 717/105; 704/E15.001

(57) ABSTRACT

An exemplary system is adapted for developing, testing, and operating payments and funds transfer systems, such as, for example, issuing systems, acquiring systems, and/or payment networks/systems. A model content repository stores elements for system models. An integrated development environment allows users to access the model content repository and design models. A deployment manager is adapted to compile and test models that have been defined and stored in the model content repository. The compiled code is executed in a platform runtime environment. Information that is collected from an executing system is communicated to the integrated development environment where the information may be presented to a user.

### CROSS-REFERENCE TO RELATED APPLICATIONS

This application claims priority to U.S. Provisional Patent Application No. 61/158,529, filed on Mar. 6, 2009, and claims priority to and is a continuation-in-part of U.S. patent application Ser. No. 12/703,162, filed on Feb. 9, 2010, the disclosures of which are incorporated herein in their entireties by reference.

### BACKGROUND

Payment networks or systems such as, for example, Visa®, MasterCard®, Discover®, American Express® and PayPal®, facilitate payments and funds transfers. Typically, such payment networks/systems are used for payment and funds transfer between two entities such as a payor and a payee. For example, a consumer may purchase goods and/or services from a merchant. In order to pay for those goods and/or services, the consumer may provide information such as a routing number, an account number, an expiration date, or the like associated with a payment instrument or account that is to be used for payment for the goods or services. The payment network/system receives information and facilitates payment and transferring the appropriate funds from the designated consumer account to the merchant's account, which often includes the provision of various support services associated with the actual payment and funds transfer. Payment networks/systems are complex and their characteristics vary considerably among payment networks/systems. The constituent groups that are served by and have commercial utility for a payment network/system, as well as the value propositions, are frequently different as among payment networks/systems. Likewise, ownership and configuration of payment networks/systems (i.e., value chains, extent of vertical integration, fragmentation and decentralization) as well as the roles and responsibilities of intermediaries (which may overlap with the constituent groups served) vary among payment networks/systems. Still further, the importance of branding also varies considerably from payment network/system to payment network/system. In some cases, like Visa and MasterCard, branding may be paramount in securing payers and payees and facilitating payments and funds transfer. In others, as with EFT or interbank ATM networks as well as EBPP networks, branding may not be as critical since participation is largely through intermediaries, such as banks, offering payment services.

The differences in payment networks/systems impact their financial performance in many respects, including revenue sources and fee structures (e.g., constituencies that are charged fees as well as fee amounts and components), expenses (e.g., cost of transfers from other payment networks, cost of maintaining infrastructure, marketing costs, and selling, general and administrative costs), and margins. The profitability for owners of different payment networks/systems can vary broadly depending on these and other factors, such as the extent of vertical integration.

Developing and managing a payment network/system can be expensive, time-consuming, and risky, including with regard to creating and maintaining the underlying technology and infrastructure to support the payment network/system. Payment networks/systems typically depend on fragmented chains of communication between multiple systems that have varying functionality such as, for example, issuing systems or acquiring systems, which ultimately limit payment utility and innovation. Additionally, typical payment networks/systems have fixed or closed-door architectures which may have divergent business goals and applicability when compared to the needs of any particular entity, community, group, or the like that may wish to make or accept payments. For example, a community may be interested in having a payment network/system that offers various incentives to use the payment network/system such as discounts for using a particular payment instrument or account. Such incentives may not be available with an existing payment network/system and the fixed or closed-door architecture of the payment network/system may prevent it from being made available. By way of further example, an entity that is interested in creating a payment network/system may also wish to define how the payment network/system is used including, for example, limiting the number of financial instruments or accounts the payment network/system supports, hierarchies of sources of funds used and accessed by the payment network/system, defining the type of financial instruments or accounts the payment network/system supports, or the like. Likewise, by way of further example, an entity that is interested in participating in a payment network/system may wish to participate in the payment network/system in some custom manner defined by that entity and permitted by the payment network/system. An existing payment network/system with a fixed or proprietary architecture and established operating procedures may not support providing such creator/user-customized operating characteristics.

Payment networks/systems often accommodate, and interface with, or encompass, systems that facilitate various types of payments, including credit, debit, prepaid or hybrid card/account payments. Typically, payment networks/systems are associated with issuing systems and acquiring systems. Generally, issuing systems refer to those activities associated with a bank, program manager or other institution that issues or provides cards/accounts to individuals and organizations that use a payment network/system to make payment. For example, a bank may issue a credit, debit, prepaid or hybrid card or account to an individual or company that then completes a payment transaction using that card or account.

Acquiring systems are typically those associated with merchants, online retailers, individuals or others accepting payments as part of the payment network/system. For example, a merchant may utilize card readers, software and connectivity in receiving payment using a card or an online shopping cart using the Internet in receiving payment using an account.

As is the case with payment networks/systems, both issuing systems and acquiring systems are complex and difficult to create. Issuing systems and acquiring systems are typically enabled by diverse groups that may include both financial and nonfinancial entities. Furthermore, these entities often have divergent business models with special value propositions and risks. Still further, organizations providing issuing systems and acquiring systems often wish to, or are required to, use different technologies to support a particular card or account program or payment or funds transfer. The complexities associated with issuing systems and acquiring systems present significant challenges, not only in terms of creating and supporting new issuing and acquiring systems to meet the demands of a constantly-changing payments marketplace, but also with respect to integrating those systems with, or incorporating them in, a payment network/system.

### SUMMARY

Applicants disclose systems and methods for developing, testing, and operating payments and funds transfer systems, such as, for example, issuing systems, acquiring systems, and/or payment networks/systems.

The disclosed systems and methods provide the capability for various issuing, acquiring and payment network organizations as well as others to respond to and manage the increasing complexities in payments. For example, the disclosed systems and methods provide the capability to design and implement systems that interface with and use new technologies, new methods of e-commerce, and emerging mobile applications. Further, the disclosed systems and methods provide organizations with the capability to define, customize, and control many aspects of an issuing system, acquiring system, and/or payment network/system. For example, the disclosed systems and methods provide for defining and customizing the characteristics of payments and funds transfers made by payors and accepted by payees. Similarly, the disclosed systems and methods provide for customizing the rules for payment networks/systems, including data structures. In a particular embodiment, for example, the disclosed systems may allow for defining and customizing rules of transaction approval or decline, when a signature is required, the period of time that is required for settlement of a transaction, and/or the period of time that is involved in making money available to the payee from a payor in connection with a transaction.

The disclosed systems and methods may be used in connection with any type of payment or funding sources including, for example, pre-funded sources (e.g., prepaid accounts, cards, and virtual cards), currently funded (e.g., debit accounts, cards, and virtual cards), pay-in-the future (e.g., credit accounts, cards, and virtual cards), and any combinations or hierarchies thereof.

An exemplary system comprises a model content repository which has elements stored therein that correspond to discrete components of an issuing system, an acquiring system, and/or a payment network/system. The elements may be combined into models for issuing systems, acquiring systems, and/or payment networks/systems. In an exemplary embodiment, the elements may comprise, for example, data flows, that may be combined into a customized model for an issuing system, an acquiring system, and/or a payment network/system. In illustrative embodiments, elements may further comprise, for example, elements defining service level agreements, business processing requirements and support functions such as Interactive Voice Response (IVR) call flows.

An exemplary system may further comprise an integrated development environment. The integrated development environment may be accessed by users to design and customize issuing system models, acquiring system models, and/or payment network/system models. Users employ the integrated development environment to combine elements stored in the model content repository into issuing system, acquiring system, and/or payment network/system models. In an exemplary embodiment, the models may employ data flow diagrams and may be stored in the model content repository. For example, users may select various elements that define functionality that the users wish to incorporate into the issuing system, acquiring system, and/or payment network/system. Elements may be directed to providing any functionality that an entity may wish to employ in connection with issuing systems, acquiring systems, and payment networks/systems. For example, some elements may correspond to account transfers, while other elements may relate to providing an Interactive Voice Response (IVR) interface. By way of further example, elements may include a template to send email notifications to an account holder when an account has been issued, templates to define or add an incentive program in a payment network/system, templates for Visa, MasterCard, and/or American Express message processing, templates for account-to-account transfers of funds, templates for load network integrations, templates for card embossing, encoding and fulfillment integrations, templates for identity verification to assist in managing card acquisition fraud, templates for defining cardholder and operator user interfaces, or any templates that may be used to define and customize an issuing system, an acquiring system, and/or a payment network/system. The elements may also include, for example, artifacts such as a plug-in module that may define a function of an issuing system, an acquiring system, and/or a payment network/system. Users drag and drop those elements into an editor area provided by the integrated development environment. Users may then define a model associated with the issuing system, acquiring system, and/or payment network/system by connecting the various elements in the editor window. Once complete, the model may then be stored in the model content repository.

An exemplary system may further comprise a deployment manager. The deployment manager is adapted to compile an issuing system, acquiring system, and/or payment network/system model that has been defined using the integrated development environment and stored in the model content repository. The deployment manager may be further adapted to perform automated testing on compiled acquiring system, issuing system, and/or payment network/system models.

An exemplary system may still further comprise a platform runtime environment where a compiled issuing system, acquiring system, and/or payment network/system executes. A switch may be communicatively coupled with the runtime environment so as to provide external connectivity to the executing application. For example, a switch may provide external connectivity to bank and credit card processing systems, load networks, communication networks, or other processing networks suitable for use with an issuing system, an acquiring system, and/or a payment network/system.

An exemplary system may also comprise a runtime analyzer that is communicatively coupled with the runtime environment and receives information from issuing systems, acquiring systems, and/or payment networks/systems that are executing in the runtime environment. In one embodiment, the runtime analyzer communicates this information to the integrated development environment where it is displayed. For example, the integrated development environment may comprise a diagram representing the model corresponding to an issuing system, acquiring system, and/or payment network/system that is executing in the runtime environment. The information received from the runtime analyzer is displayed in the integrated development environment on the portion of the model that corresponds to the received information. According to another embodiment, the integrated development environment may receive the information about executing systems or networks directly from the executing systems or networks and thereby bypass the runtime analyzer. In an exemplary embodiment, the model content repository maintains versioning information for models and the elements that are used to define the models. Thus, when an existing model is modified, the model content repository records the modifications to the model and stores it with new versioning information. Likewise, when an element is changed, new versioning information is stored with the element. When a change is made to either an element or a template, the deployment manager may be adapted to recompile those portions of the code affected by the changes and test the recompiled code. After verification, the recompiled code is placed in the runtime environment.

The exemplary platform for developing, testing, and executing issuing systems, acquiring systems, and/or payment networks/systems may be made available as a service. Users may access the platform as-needed to develop a model of such systems and networks, to compile and test code corresponding to the model, and/or to execute the systems or networks. Users can access as much or as little of the platform functionality as suits their particular needs. For example, in an exemplary scenario, a user may access the platform to develop and test an issuing system, acquiring system, and/or payment network/system model, but may use resources, e.g., the user's own servers, other than the platform to execute the issuing system, acquiring system, and/or payment network/system associated with such models in a production environment.

The disclosed development platform allows entities to, among other things, implement customized issuing systems, acquiring systems, or payment networks/systems and thereby allows organizations to leverage existing assets to create competitive offerings. The disclosed systems and methods are able to accommodate the custom requirements of each organization and thereby provide high levels of product and service quality at low total cost of ownership.

The disclosed systems and methods provide the capability to generate fully integrated payment networks/systems for a particular entity. The development environment allows for defining segregated, custom account-on-file systems designed to interface with payer- and payee-groups specific to the utility of the particular payment network/system. Likewise, the disclosed development platform provides for end-to-end processing for a full range of ongoing transactions as part of the payment system—including issuing systems and acquiring systems—and support for all payment types, including: prepaid, debit, credit and hybrids; physical and virtual; reloadable and nonreloadable.

In an exemplary embodiment, the disclosed systems and methods for developing and implementing issuing systems, acquiring systems and payment networks/systems support payments and funds transfer for commerce conducted in a broad range of business ecosystems, including those based on Internet, mobile, offline and other commerce, that represent diversified interactions among, and communities of, organizations, individuals, technologies, and products and services. Using the disclosed systems and methods described herein, entities design and implement issuing systems, acquiring systems, and payment networks/systems for all types of marketplaces and venues where buyers and sellers can transact. Similarly, the disclosed systems and methods support the creation of payments and funds transfer systems that rely on the Internet and mobile phones, including multi-application smart phones, which facilitate various forms of remote electronic commerce as well as access to demographics around the world which historically have been unable to participate in electronic financial services.

The disclosed systems and methods support the creation of issuing systems, acquiring systems, and payment networks/systems that expand the reach of electronic payments. For example, payment networks/systems may be developed that are facilitated by entities that have not historically engaged in the payments business. For example, using the disclosed systems and methods, payment networks/systems may be extended to facilitate smaller payment amounts and in new locations, such as online, through mobile devices or in micropayment retail for goods like digital content. Likewise, the disclosed systems and methods may be used to develop payment networks/systems that are relevant in contexts where non-network payment systems, including paper, have historically been dominant.

Furthermore, the disclosed systems and methods support improvements in technology and new ways in which organizations collaborate to co-create and co-manage technology to meet more specialized electronic payments needs and achieve greater operational efficiency in the long tail of the payments demand curve. The disclosed development platforms serve markets of niches and concurrently mass markets of payments and funds transfer. The disclosed development environment allows payment and funds transfers to move away from one-size-fits all in favor of more customized and individualized solutions. This distributed and collaborative development has not historically been part of how companies enable issuing systems, acquiring systems or payment networks/systems. This distribution of development supports improved (and in some cases optimal) allocation of roles and responsibilities in the payments and funds transfer value chain, and can reduce (or even practically eviscerate) the distinction between in-house systems and outsourced systems, and in the process permit organizations to operate more efficiently, including at lower cost, quicker time to market, and higher quality.

### BRIEF DESCRIPTION OF THE DRAWINGS

FIG. 1 depicts an example embodiment of a network configuration for developing, providing, and managing an issuing system, an acquiring system, and/or a payment network/system.

FIGS. 2-3 depict example embodiments of systems and applications for developing, providing, and managing an issuing system, an acquiring system, and/or a payment network/system.

FIGS. 4-6 depict example interfaces of an integrated development environment that may be used to develop, provide, and manage an issuing system, an acquiring system, and/or a payment network/system.

FIG. 7 depicts a flow diagram of an exemplary method for defining and/or developing a model for an issuing system, an acquiring system, and/or a payment network/system.

FIG. 8 depicts a flow diagram of an exemplary method for defining a model for an issuing system, an acquiring system, and/or a payment network/system.

FIG. 9 depicts a flow diagram of an exemplary method for defining and/or developing a model for an issuing system, an acquiring system, and/or a payment network/system.

FIG. 10 depicts a flow diagram of an exemplary method for managing an issuing system, acquiring system, and/or payment network/system model.

FIG. 11 depicts a flow diagram of an exemplary method for providing version management in an issuing system, an acquiring system, and/or a payment network/system.

FIG. 12 depicts an example embodiment of a matrix that may be used to define business requirements for an issuing system, an acquiring system, and/or a payment network/system.

FIG. 13 depicts a flow diagram of exemplary processing for integrating business requirements into an issuing system, an acquiring system, and/or a payment network/system.

FIG. 14 depicts a flow diagram of an exemplary processing model for integrating service level agreements into an issuing system, an acquiring system, and/or a payment network/system.

FIG. 15 depicts a flow diagram illustrating operation of a model defining an issuing system, an acquiring system, and/or a payment network/system that has desired service levels specified therein.

FIG. 16 depicts a flow diagram of an exemplary process for integrating process monitoring into an issuing system, an acquiring system, and/or a payment network/system.

FIG. 17 depicts a flow diagram illustrating operation of a model defining an issuing system, an acquiring system, and/or a payment network/system that has desired processing monitoring elements specified therein.

FIG. 18 depicts a flow diagram illustrating an exemplary process of providing an issuing system, acquiring system, and/or payment network/system platform as a service.

FIG. 19 depicts a flow diagram illustrating an exemplary process of establishing an issuing system, an acquiring system and/or a payment network/system.

FIG. 20 depicts a block diagram of an exemplary computing environment that may be used to implement the systems and methods described herein.

### DETAILED DESCRIPTION OF ILLUSTRATIVE EMBODIMENTS

### Overview

An exemplary system is adapted for designing models for issuing systems, acquiring systems, and/or payment networks/systems, using the models to generate code for the systems, testing the code, and executing the code in order to implement the issuing systems, acquiring systems, and/or payment networks/systems. While the concepts are described with reference to systems and methods for issuing systems, acquiring systems, and/or payment networks/systems, it is appreciated and understood that issuing systems, acquiring systems, and/or payment networks/systems refers to and includes facilitating payments and funds transfer relating to any and all types of financial transactions.

In an illustrative embodiment, an exemplary system comprises a model content repository in which elements for issuing system, acquiring system, and/or payment network/system models are stored. An illustrative system further comprises an integrated development environment that allows users to access the model content repository and design issuing system, acquiring system, and/or payment network/system models using the elements stored in the model content repository.

A deployment manager is adapted to compile and test issuing system, acquiring system, and/or payment network/system models that have been defined and stored in the model content repository. The compiled code is executed in a runtime environment. Information that is collected from an executing issuing system, acquiring system, and/or payment network/system may be communicated to the integrated development environment where the information may be presented to a user.

The development environment may be offered as a platform to organizations to develop systems that accommodate their custom requirements. The development environment provides for creating and operating segregated, custom issuing systems, acquiring systems and payment network/systems. For example, an organization can define the individuals that may access or have an account in the network or system and particulars of how payments and funds transfers are executed. An organization may define payments and funds transfers for a range of ongoing transactions. Support for all payment types is provided, including, for example, prepaid, debit, credit and hybrids, physical and virtual, and reloadable and non-reloadable.

### Exemplary Network Configuration

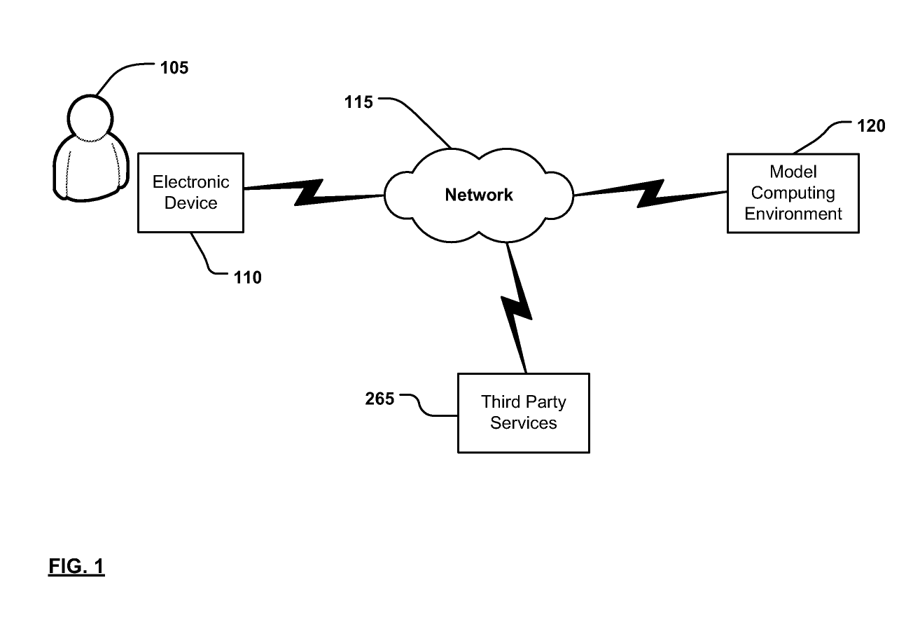

FIG. 1 depicts an example network configuration for implementing a system for developing and executing an issuing system, an acquiring system, and/or a payment network/system. As shown in FIG. 1, an exemplary network configuration may comprise a model computing environment 120. The model computing environment 120 provides a platform for developing issuing system, acquiring system, and/or payment network/system models, for compiling code, and for executing issuing systems, acquiring systems, and/or a payment networks/systems. According to an example embodiment, model computing environment 120 may comprise a plurality of server networks, which may be geographically distributed.

Users may employ electronic devices 110 to access the model computing environment 120 over a network 115. Users design and deploy issuing systems, acquiring systems and payment networks/systems at the computing environment 120 using the devices 110. The electronic devices 110 may be any device suitable for interfacing with model computing environment 120 including, for example, personal computing devices. Additionally, the network 115 may comprise any communications technology for providing connectivity including, for example, wireless networks, cable networks, and/or a local- or wide-area networks including, for example, a corporate intranet and/or the Internet.

Third party services 265 may also be accessed by the model computing environment 120 while executing an issuing system, an acquiring system, and/or a payment network/system. For example, an issuing system, an acquiring system, and/or a payment network/system may access a banking network such as an ACH network, a load network, a communication network, a credit card network, or any other type of network suitable for use with an issuing system, an acquiring system, and/or a payment network/system.

Exemplary Issuing System, Acquiring System, and/or Payment Network/System Development

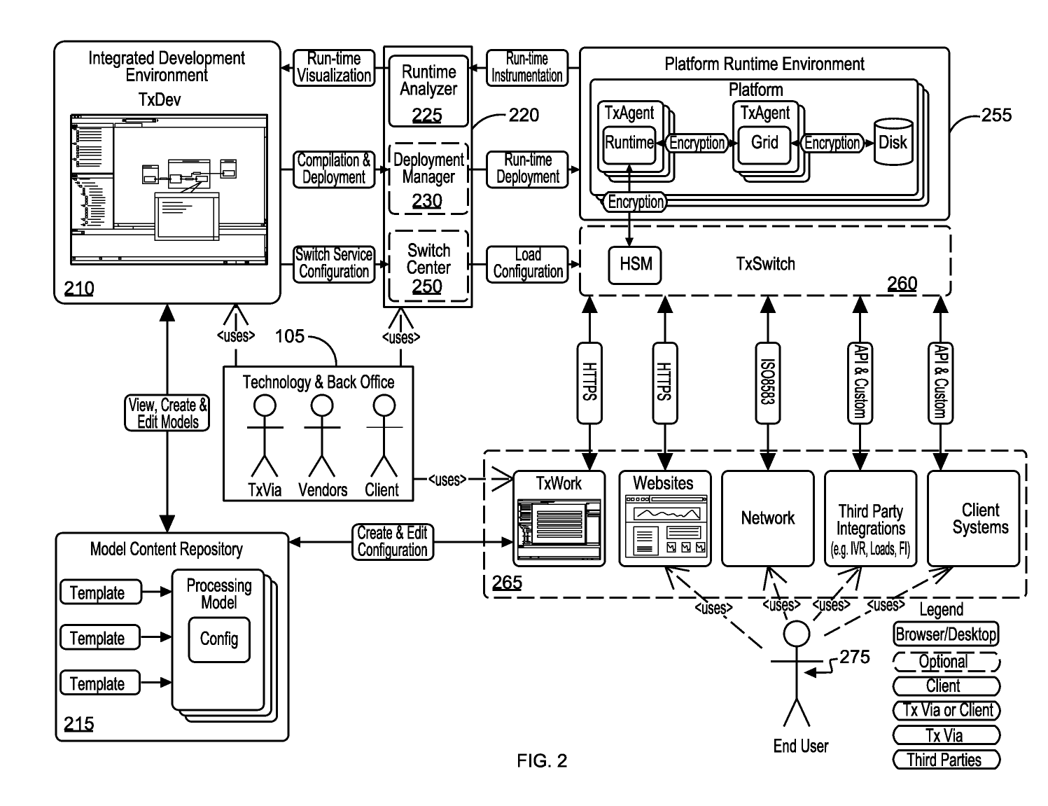

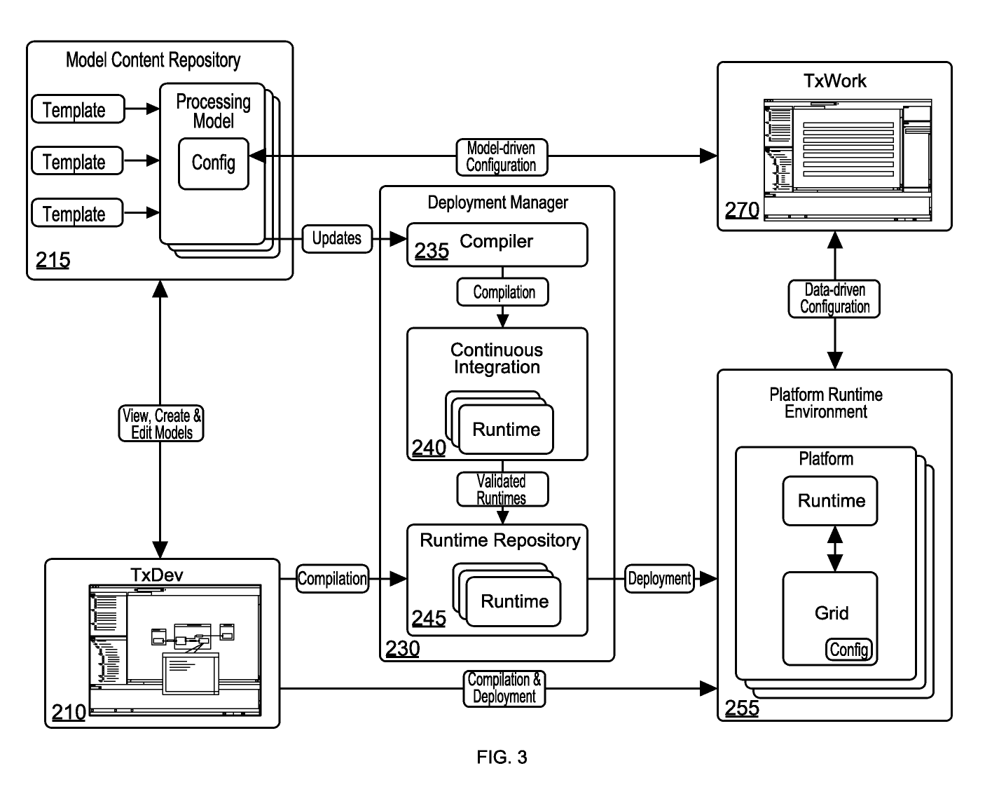

FIGS. 2-3 depict example embodiments of systems and applications for developing, providing, and managing an issuing system, an acquiring system, and/or a payment network/system. As shown in FIG. 2, a development user 105 such as a programmer, system developer, or the like may access an integrated development environment (IDE) 210 to, for example, develop, edit, and/or manage an issuing system, an acquiring system, and/or a payment network/system. According to example embodiments, the development user 105 may include a programmer, a system developer, a client, a vendor, a back office operation, or the like that may access or interact with the IDE 210 to streamline issuing system, acquiring system, and/or payment network/system services. For example, in one embodiment, the development user 105 may include a representative of a back office operation that may access and/or interact with the IDE 210 to streamline operations such as risk operations (e.g. disputes and chargebacks, negative balance management, fraud monitoring Know Your Customer (KYC) rules), payment network/system services, issuing services, acquiring services, customer services, switch services, manufacturing services, embossing services, encoding services, or any other suitable operation.

The IDE 210 may be a product engineering application that may provide one or more interfaces that the development user 105 may interact with to develop, edit, and/or manage an issuing system, an acquiring system, and/or a payment network/system. According to an example embodiment, the interfaces may include elements associated with processes of an issuing system, an acquiring system, and/or a payment network/system such as templates, data flow diagrams, artifacts or the like, which will be described in more detail below. The development user 105 may select the elements provided via the interfaces to produce a customized model associated with an issuing system, an acquiring system, and/or a payment network/system. In one embodiment, the IDE 210 may be used to generate, for example, software code such as computer-readable instructions that may include the functionality and/or processes for the model. For example, the IDE 210 may include a bundle repository (not shown) that may include software code such as computer-readable instructions associated with various functions that may be performed in the model.

According to an example embodiment, the development user 105 may interact with, for example, the electronic device 110, shown in FIG. 1, to launch the IDE 210. The electronic device 110 may include hardware components such as a processor, a graphics card, a storage component, a memory component, an antenna, a communication port, a display, an input device, or the like. The electronic device 110 may also include software components such as an operating system and a web browser application that may control the hardware components. According to example embodiments, the electronic device 110 may be, for example, a computer, a telephone, a PDA, a server, or the like.

As described above, the electronic device 110 may be in operative communication with the model computing environment 120. In one embodiment, the model computing environment 120 may deploy and/or host the IDE 210. For example, an entity such as a vendor may remotely host the IDE 210 on a computing system such that the development user 105 may interact with, for example, a web browser application on the electronic device to access the IDE 210. According to example embodiments, the electronic device 110 may be in operative communication with, for example, the model computing environment 120 that may deploy the IDE 210 via the network 115.

As will be described below, the model computing environment 120 may include any combination of hardware components such as processors, databases, storage drives, registers, cache, RAM memory chips, data buses, or the like and/or software components such as the IDE 210, operating systems, or the like. In one embodiment, the model computing environment 120 may be a network-based server that may provide the IDE 210 to the electronic device 110 such that the development user 105 may interact with the IDE 210 to develop an issuing system, an acquiring system, and/or a payment network/system.

The IDE 210 may be in communication with a model content repository (MCR) 215. The MCR 215 may include and/or be implemented in any combination of hardware components such as processors, databases, storage drives, registers, cache, RAM memory chips, data buses, or the like. In an example embodiment, the MCR 215 may be implemented in the model computing environment 120. According to one embodiment, the MCR 215 may store elements associated with one or more defined processes that may be used in an issuing system, an acquiring system, and/or a payment network/system. The elements may include, for example, templates, artifacts, data flow diagrams, or the like associated with defined processes of issuing systems, acquiring systems, and/or payment networks/systems. For example, the elements may include a template to add email notifications to an account holder when an account has been issued, templates to define or add an incentive program in a payment network or system, templates for Visa, MasterCard, and/or American Express message processing, templates for account-to-account transfers of funds, templates for load network integrations, templates for card embossing, encoding and fulfillment integrations, templates for identity verification to assist in managing card acquisition fraud, templates for defining cardholder and operator user interfaces, or any templates that may be used to define and customize an issuing system, an acquiring system, and/or a payment network/system. The elements may also include, for example, artifacts such as a plug-in module that may define a function of an issuing system, an acquiring system, and/or a payment network/system. The elements may further include, for example, a data flow diagram that may be a visual depiction associated with data synchronizations, data sources, transformations, or the like. According to an example embodiment, the development user 105 may interact with the IDE 210 to select elements for inclusion in a development model associated with an issuing system, an acquiring system, and/or a payment network/system. Thus, in one embodiment, the MCR 215 may provide the elements to the IDE 210 such that the development user 105 may select the elements to develop an issuing system, an acquiring system, and/or a payment network/system.

According to an example embodiment, the IDE 210 may be in communication and/or interact with middleware applications 220. According to an example embodiment, the middleware applications 220 may be included in the model computing environment 120. The middleware applications 220 may be one or more applications that may act as an intermediary between the IDE 210 and a platform runtime environment 255, which will be described in more detail below. As shown in FIG. 1, the middleware applications 220 may include a runtime analyzer 225, a deployment manager 230, and a switch center 250.

According to one embodiment, the runtime analyzer 225 provides feedback from an executing issuing system, acquiring system, and/or payment network/system that may have been developed using the IDE 210. For example, the runtime analyzer 225 may store information associated with an executing model of an issuing system, an acquiring system, and/or a payment network/system developed by, for example, the development user 105 using the IDE 210. The runtime analyzer 225 may receive and record streams of data associated with the executing model from the platform runtime environment 255. For example, as will be described below, a model of an issuing system, an acquiring system, and/or a payment network/system developed with the IDE 210 may be compiled and deployed to the platform runtime environment 255. The platform runtime environment 255 may then host the executing issuing system, acquiring system, and/or payment network/system associated with the model. As the issuing system, acquiring system, and/or payment network/system associated with the model executes, the runtime analyzer 225 may receive and record the executing model such that the IDE 210 may provide a visual depiction of, for example, transactions or data being processed by the executing model, which will be described in more detail below.

The deployment manager 230 may be an application that compiles, tests, and deploys an issuing system, an acquiring system, and/or a payment network/system model developed with the IDE 210. For example, as shown in FIG. 3, the deployment manager 230 may include a compiler 235, an integration module 240, and a runtime repository 245. In one embodiment, the compiler 235 may receive a model developed with the IDE 210. Upon receipt of the model, the compiler 235 may compile the elements of the model into executable code associated with processes and/or functionality of an issuing system, an acquiring system, and/or a payment network/system to which the elements correspond.

The executable code may then be provided to integration module 240. The integration module 140 may verify the executable code by performing testing on the code to determine that it operates correctly. The tests may be automated but may also be performed manually per user inputs. The testing may also determine whether the executable code, which may represent recent changes to a model, may be properly deployed in a version of the model that may be executing in the platform runtime environment.

According to an example embodiment, the verified or validated executable code may be provided to the runtime repository 245. The runtime repository 245 may stream bundles of the compiled executable code to the platform runtime environment 255 such that the platform runtime environment 255 may install the bundles to execute the model, to update an existing model that may be executing, resolve dependencies of an existing model that may be executing, or the like. In one embodiment, the bundles of the compiled code may be checked out until the bundles may be verified and/or validated. Upon verification and/or validation, the bundles may then be checked in and provided to the platform runtime environment 255 such that the platform runtime environment 155 listens for the bundles of executable code, installs, and begins executing them via a platform thereon.

As shown in FIG. 2, the middleware applications 220 may further include the switch center 250 in an example embodiment. The switch center 250 may be an application that may provide communication between a switch 260 that may be included in the platform runtime environment 255 and the IDE 210. For example, the development user 105 may interact with the IDE 210 to select an element associated with a third party service such as a Visa, MasterCard, American Express or the like processing system, an Interactive Voice Response (IVR) system, a web-based account system, or the like that may be accessed by the model executing in the platform runtime environment 255. The switch center 250 may receive a configuration associated with such a service based on the model developed using the IDE 210. The configuration may include, for example, protocols, requirements, or the like associated with the services selected to be included in the model. The switch center 250 may then provide the configuration to the switch 260 such that the switch 260 may load the configuration including the protocols, requirements, or the like to provide communication between the platform runtime environment 255 and the third party services 265 associated with the configuration, which will be described in more detail below. The development user 105 may also interact with the switch center 250 to update one or more configurations in the switch 260 after an initial deployment.

As described above, the platform runtime environment 255 may execute an issuing system, an acquiring system, and/or a payment network/system corresponding to a model that may have been developed with the IDE 210. In one embodiment, as shown in FIGS. 2-3, the platform runtime environment 255 may include a platform to execute each model that may be developed using the IDE 210. The platform may include a grid that may store, host, and execute the model. In an example embodiment, the platform and the grid may receive bundles of code corresponding to the model from the deployment manager 230, as described above. The bundles may then be installed on the platform and grid such that the platform runtime environment 255 may execute the model.

According to one embodiment, the switch 260 may be used to provide an interface between the platform runtime environment 255 and third party services 265 that may be available to, for example, a cardholder 275 of a stored value card associated with the payment card processing system, issuing system, acquiring, system, and/or payment network/system hosted by the platform runtime environment 140. For example, the model may include a third party service such as a Visa, MasterCard, American Express or the like processing system, an Interactive Voice Response (IVR) system, a web-based cardholder self-service system, or the like that may be accessed by the model executing in the platform runtime environment 255. The switch 260 may provide an interface to direct information between the model executing on a platform in the platform runtime environment 255 and the third party services 265. In an example embodiment, the switch 260 may encrypt and/or decrypt the information between the model executing on the platform in the platform runtime environment 255 and the third party services 265.

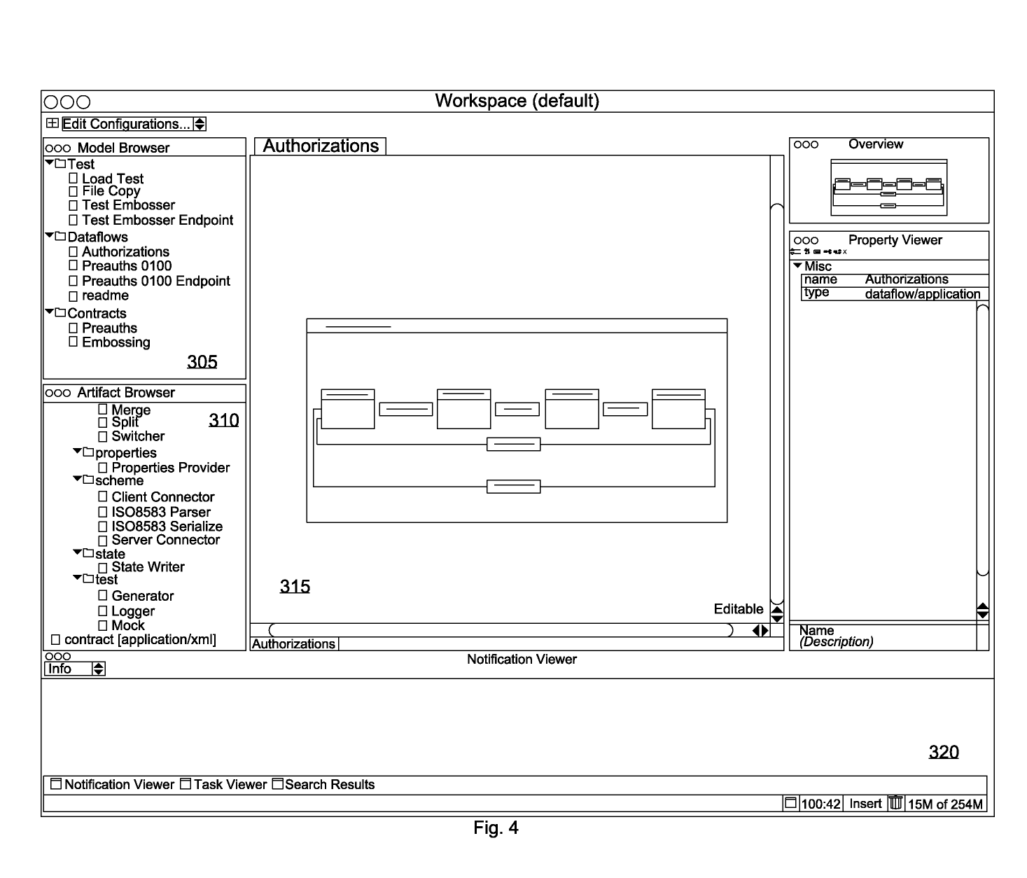

FIGS. 4-6 depict example interfaces of an integrated desktop environment such as the IDE 210, shown in FIGS. 2-3 that may be used to develop, provide, and manage an issuing system, an acquiring system, and/or a payment network/system. As shown in FIGS. 4-6, the interfaces may include a model browser 305 and an artifact browser 310. The model browser 305 may include a window that illustrates elements that may be selected for a model. For example, various data flow diagrams may be generated to be included in the model. The model browser 305 may show the generated data flow diagrams such that the development user 105 may select a representation such as a name associated with a particular data flow diagram in the model browser 305 to provide the data flow in a model editor 315 provided by the IDE 110.

The artifact browser 310 may include a window that may provide one or more elements such as artifacts, templates, data flow diagrams, data dictionaries, workflows, or the like that may be selected and developed to define the model. For example, the artifact browser 310 may provide a list of the elements supported by the IDE 210. In an example embodiment, the development user 105 may select and drag and drop an element from the artifact browser 310 to the editor 315 to define the model for the issuing system, acquiring system, and/or payment network/system being developed. In an exemplary embodiment, artifacts supported by the IDE 210 and available for browsing might include, for example, an Atalla component such as a secure cryptographic processor configured for high security applications, a business calendar, a call flow, a client connector, a contract, a data flow, a deployment, a data dictionary, an endpoint, an environment, an event listener or handler function, a file format, a folder, a functions library, an HTTP client, an ISO 8583 format or a specification for defining the exchange of messages for electronic transactions, an interactive voice recognition (IVR) module, a job definition, a key store, a Lightweight Directory Access Protocol (LDAP) connector, a network message format, a property, a remote endpoint, a requirements catalog, a runtime test case, a server connection or connector, a Short Message Peer-to-Peer (SMPP) connector for exchanging Short Message Services (SMS) messages, a stores definition, a test case, a test plan, text, a form, a site, a module, an audio file, a web test case, a workflow, a workflow extension, a web service client or server connector, or the like.

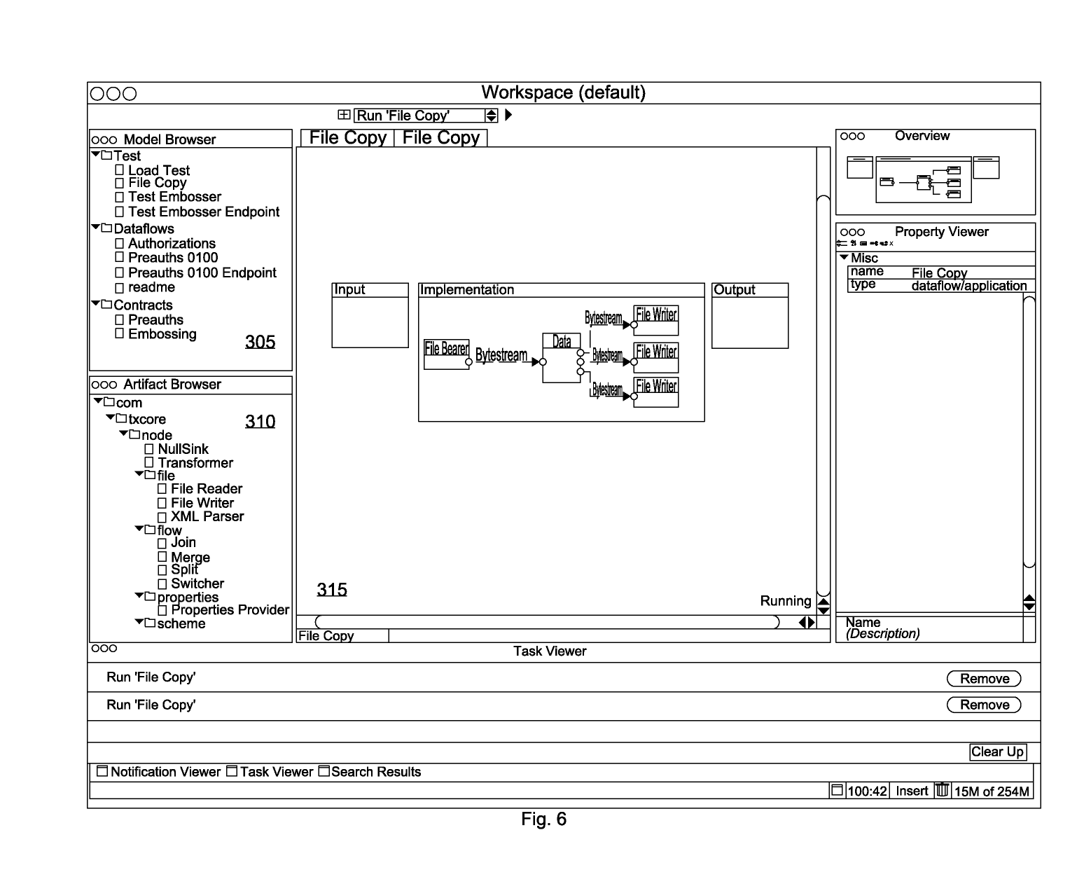

According to an example embodiment, the interfaces may further include the model editor 315. The model editor 315 may comprise a widow that may be used to create a new model, change an existing model, manage a model, or the like. For example, as describe above, the development user 105 may select elements from the artifact browser 310 to add to the model editor 315. The development user 105 may then assign, define, edit, and/or manipulate values, properties, inputs, outputs, or the like for the element with the model editor 315. In one embodiment, the model displayed in the model editor 315 may provide real-time and/or recorded feedback from the platform runtime environment 255, shown in FIG. 2. As described above, the runtime analyzer 225 may receive and record the information during execution in the platform runtime environment 225. For example, the runtime analyzer 225 may receive and record information associated with a transaction for the model during the execution of the transaction on the platform runtime environment 255. The information may then be provided to the IDE 210 such that the elements associated with the model displayed in the model editor 315 may be animated to illustrate the transaction. For example, in FIG. 6, dotted lines are shown on the model in the model editor 315 to illustrate data collected during execution of an issuing system, an acquiring system, and/or a payment network/system that corresponds to the displayed model.

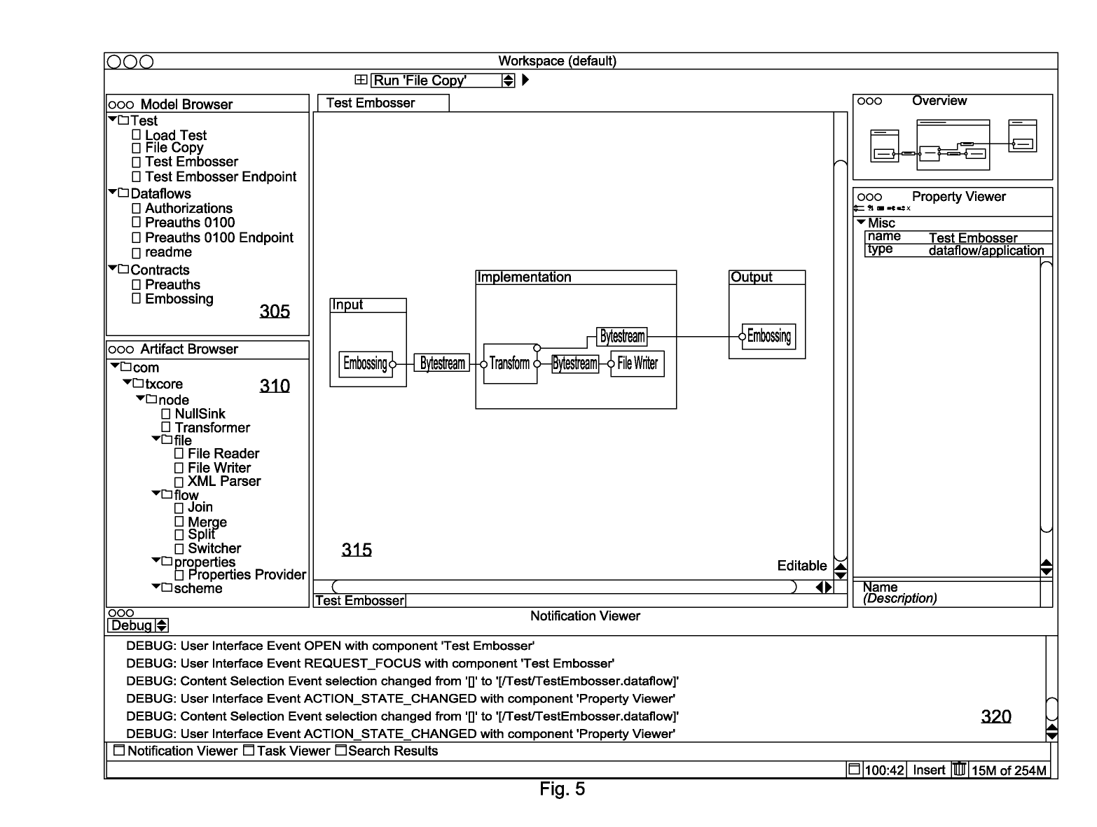

As shown in FIGS. 4-5, the interfaces may also include a notification window 320. The notification window 320 may provide information that may be used to debug errors in the model shown in, for example, the model editor 315. For example, as described above, the deployment manager 130 may compile the model into executable code. During compilation, one or more errors may be found in the model. In one embodiment, the IDE 210 may receive the errors from the deployment manger 130 and display the errors in the notification window 320 as shown in FIG. 5. The development user 105 may then interact with the notification window 320 to debug the elements of the model that may be causing the errors.

According to another embodiment, the IDE 210 may include a command-line interface. The command line-interface may be a text interface designed to perform compilation and/or deployment of a model in a non-graphical environment.

### Model Driven Architecture

As noted above, elements such as, for example, data flow diagrams, work flow diagrams, data dictionaries, or the like may be stored in the MCR 215. The stored elements may also comprise templates which are pre-defined arrangements of component elements such as data flow diagrams, workflows, etc. According to an example embodiment, the elements may be provided to the IDE 210 such that a user may interact with the IDE 210 to select the elements to define a model associated with an issuing system, an acquiring system, and/or a payment network/system. The model may then be compiled into bundles, and after validation, may be placed in a production environment for use in facilitating payments and funds transfer, including processing financial transactions, issuing accounts, acquiring funds, providing related customer support, or the like.

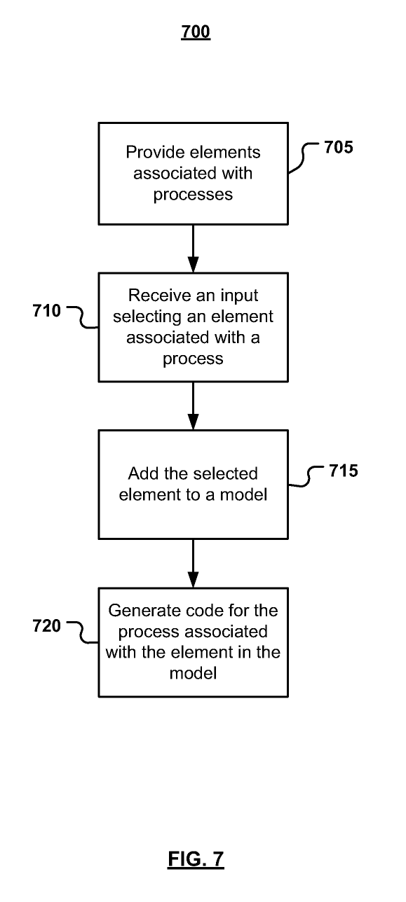

FIG. 7 depicts a flow diagram of an exemplary method for defining and/or developing a model for an issuing system, an acquiring system, and/or a payment network/system. As shown in FIG. 7, at step 705, one or more libraries of elements for use in defining an issuing system, an acquiring system, and/or a payment network/system may be provided. For example, elements such as artifacts, data flow diagrams, templates, or the like that may be stored in the MCR 215 or IDE 210 may be made accessible to, for example, the development user 105 or operator via the IDE 210. In an exemplary embodiment, the development user 105 may access, for example, screens such as those depicted in FIGS. 4 through 6.

At step 710, the IDE 210 and the MCR 215 may receive inputs selecting and arranging an element such as an artifact, data flow diagram, template, or the like associated with a process of an issuing system, an acquiring system, and/or a payment network or system. The inputs may be entered by, for example, a development user or operator of the IDE 210.

When the development user or operator has completed selecting and arranging the element, at step 715, the selected element may be added to an issuing system, an acquiring system, and/or a payment network/system model. The model including the selected element, e.g., the artifacts, data processing diagrams, templates, or the like may be stored in the MCR 215.

At step 720, object code may be created for the newly created issuing system, acquiring system, and/or a payment network/system model. For example, object code for the process associated with the element in the model may be created. According to an example embodiment, the deployment manager 230 may compile the model including the selected element into a format that may be executed. Thereafter, the code may be deployed to the platform runtime environment where it is executed. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied.

### Meta-Model

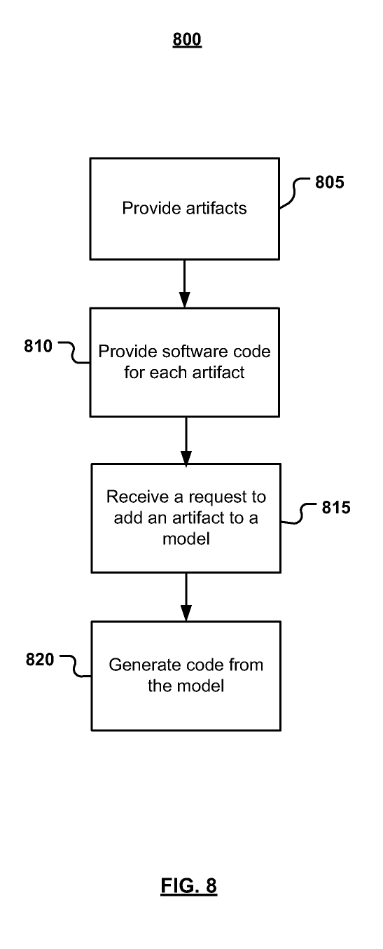

FIG. 8 depicts a flow diagram of an exemplary method for defining a model for an issuing system, an acquiring system, and/or a payment network/system. As shown in FIG. 8, at step 805, a plurality of artifacts may be provided for use in defining an issuing system, an acquiring system, and/or a payment network/system. For example, the artifacts that may be stored in the IDE 210 and/or MCR 115 may be made accessible to a development user or operator via the IDE 210. In an exemplary embodiment, the artifacts may be made accessible using interfaces such as those depicted in FIGS. 4 through 6. In an example embodiment, each of the artifacts may correspond to a process for use in an issuing system, an acquiring system and/or a payment network/system.

At step 810, software code for each of the plurality of artifacts is provided by a bundle repository which may included in, for example, the IDE 210. The software code may include object code to implement the process associated with the artifacts. In an example embodiment, the artifacts may be pre-defined and associated with the software code in the bundle repository prior to being stored in the MCR 215.

At step 815, the MCR 215 may receive a request to select and/or add an artifact to a model defining an issuing system, an acquiring system, and/or a payment network/system. The request may be entered by, for example, a development user or operator of the IDE 210. Upon receiving a request, the artifact may be displayed to the development user via the model editor 315 of the IDE 210. The model including the selected and/or added artifact may be stored in the MCR 215.

When the development user or operator has completed selecting and/or adding an artifact to the model, at step 820, object code may be created for the newly created issuing system, acquiring system, and/or payment network/system model. Software code or content associated with the selected artifact may be responsible for compiling content whose structure may be defined by the selected artifact into executable code such as the object code. For example, where a user has incorporated a particular artifact content into the issuing system, acquiring system, and/or payment network/system model, software code associated with the particular artifact (perhaps stored in a bundle repository) compiles code for implementing the particular artifact content as it exists in the particular model. In an even more particular example, where a process model comprises an instance of a data flow artifact, which may be referred to as data flow content, software code associated with the data flow artifact compiles or creates code for implementing the particular instance of the data flow as it exists in the particular model. According to an example embodiment, the deployment manager 230 may compile the model into a format that may be executed. Thereafter, the code may be deployed to the platform runtime environment where it is executed. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied.

It should be appreciated that providing a development environment that relies upon a model driven architecture to define issuing systems, acquiring systems and payment networks/systems provides the benefit of decoupling design from some of the technical details of implementation which enhances the efficiencies in system development.

### Data Flow Implementation Architecture

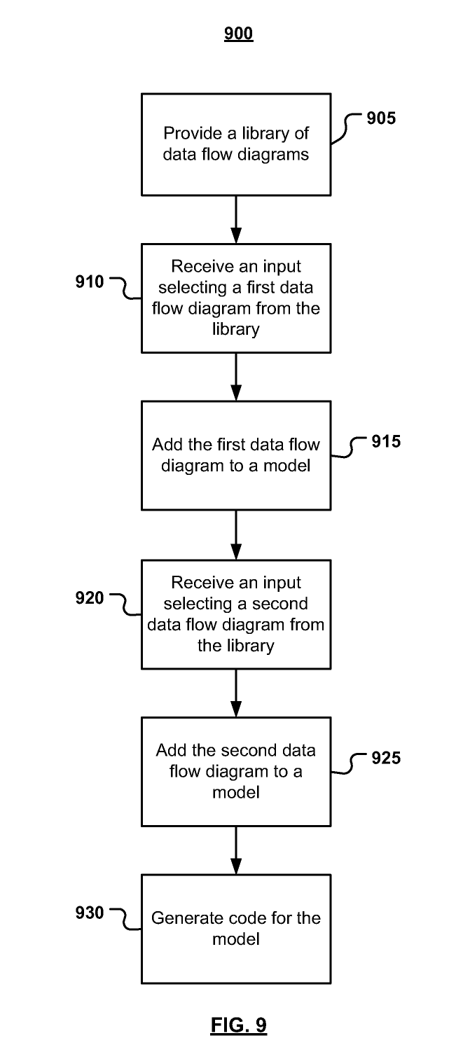

FIG. 9 depicts a flow diagram of an exemplary method for defining and/or developing a model for an issuing system, an acquiring system, and/or a payment network/system. In an illustrative embodiment, data flow diagrams represent discrete sets of functionality that may be employed in an issuing system, an acquiring system, and/or a payment network/system. For example, a data flow diagram may be an instance of an artifact having particular content associated therewith. As shown in FIG. 9, at step 905, a library of data flow diagrams for use in defining an issuing system, an acquiring system, and/or a payment network/system may be provided. For example, the data flow diagrams that may be stored in the MCR 215 may be made accessible to a development user or operator via the IDE 210. In an exemplary embodiment, the data flow diagrams may be made accessible using interfaces such as those depicted in FIGS. 4 through 6. According to an example embodiment, each of the data flow diagrams may correspond to a process that may be used in an issuing system, an acquiring system, and/or a payment network/system.

At step 910, the MCR 215 may receive an input selecting a first data flow diagram from the library of data flow diagrams that may be stored therein. The input may be entered by, for example, a development user or operator of the IDE 210.

The first data flow diagram selected, at step 910, may be added to an issuing system, an acquiring system, and/or a payment network/system model at step 915. The data flow diagram is added to the model at a location in the model as defined by the user input. The data flow diagram is added at the location defined by the user input. The model including the selected first data flow diagram may be stored in the MCR 115.

At step 920, the MCR 215 may receive an input selecting a second data flow diagram from the library of data flow diagrams that may be stored therein. The input may be entered by, for example, the development user 105 or operator of the IDE 210.

The second data flow diagram selected, at step 920, may then be added to the issuing system, acquiring system, and/or payment network/system model at step 925. In an illustrative scenario, the second data flow diagram may be positioned in the model adjacent to the first data flow diagram whereby an output of the first data flow diagram serves as an input to the second data flow diagram. The issuing system, acquiring system, and/or payment network/system model including the selected first and second data flow diagrams may be stored in the MCR 215.

At step 930, object code may be created for the newly created issuing system, acquiring system, and/or payment network/system model. For example, object code for the processes associated with the selected first and second data flow diagrams in the model may be created. According to an example embodiment, the deployment manager 230 may compile the model including the selected first and second data flow diagrams into a format that may be executed. Thereafter, the code may be deployed to the platform runtime environment where it is executed. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied.

### Tool and Platform Deployment Architecture

As noted above, elements such as, for example, artifacts, data flow diagrams, templates or the like may be used to create an issuing system, an acquiring system, and/or a payment network/system model. For example, a development user may interact with the IDE 210 to select elements to define a model associated with an issuing system, an acquiring system, and/or a payment network/system. The model may then be compiled into bundles, and after validation, may be placed in a production environment for use in issuing accounts and/or credit, acquiring funds, facilitating and/or processing payment transactions, or the like. In an example embodiment, an element may be changed after deployment of the model such that an updated model reflecting the change to the element may be created. The updated model may then be compiled into bundles, and after validation, may be placed in a production environment for use in issuing accounts and/or credit, acquiring funds, facilitating and/or processing payment transactions, or the like. In one embodiment, only the changes to the elements and not the entire model may be re-compiled and placed in the production environment.

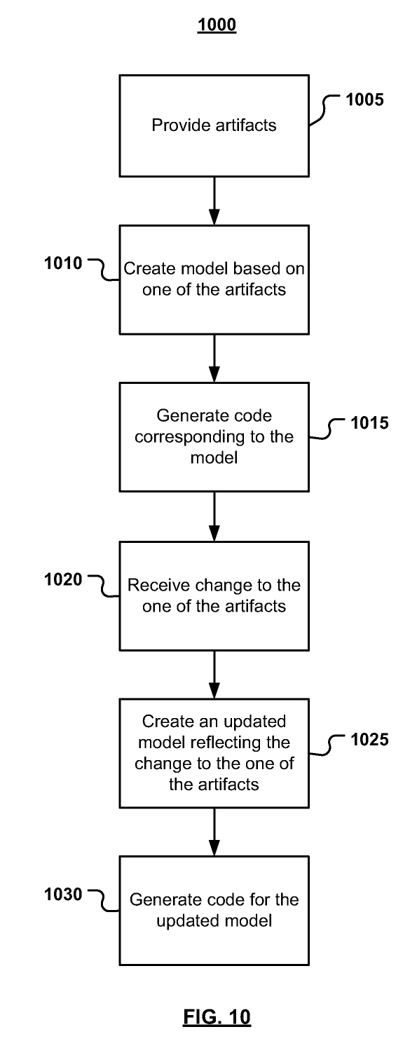

FIG. 10 depicts a flow diagram of an exemplary method for managing an issuing system, an acquiring system, and/or a payment network/system model. As shown in FIG. 10, at step 1005, a plurality of artifacts may be provided to be used to define an issuing system, an acquiring system, and/or a payment network/system. For example, the artifacts that may be stored in the IDE 210 or the MCR 215 may be made accessible to the development user 105 or operator via IDE 210. In an example embodiment, each of the artifacts may correspond to a process for use in an issuing system, an acquiring system, and/or a payment network/system.

At step 1010, an issuing system, an acquiring system, and/or a payment network/system model may be created based on one of the artifacts. For example, the development user 105 or operator may interact with the IDE 210 to select an artifact. The artifact may then be added to the issuing system, acquiring system, and/or payment network/system model that may be stored in, for example, the MCR 115.

At step 1015, object code may be created for the newly created issuing system, acquiring system, and/or payment network/system model. For example, object code for the process associated with the artifact in the model may be created. According to an example embodiment, the deployment manager 230 may compile the model including the selected artifact into a format that may be executed.

At step 1020, a change may be received to the artifact. For example, the development user or operator may change a property, value, input, output, or the like associated with the artifact. Alternatively, the artifact may be automatically updated to reflect a change in a processing requirement, security protocol, or the like associated therewith.

At step 1025, an updated model reflecting the change to the artifact may be created. In an exemplary embodiment, the updated model may be automatically generated in response to the change to the artifact. The updated model may be stored in, for example MCR 215.

Upon creating the updated model, object code may be created for the updated issuing system, acquiring system, and/or payment network or system model at 1030. For example, object code for the process associated with the changed artifact in the model may be created. According to an example embodiment, the deployment manager 230 may compile the changed artifact into a format that may be executed. Thereafter, the code may be deployed to the platform runtime environment where it is executed. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied.

### Version Change Management

According to another aspect of potential embodiments, the system may perform version management on system objects and manage the impact of version changes on other objects in the system. As noted above, elements such as, for example, templates may be stored in the MCR 215. Elements such as artifacts may be stored in, for example, the IDE 210. These elements are used to define issuing system, acquiring system, and/or payment network/system models. The issuing system, acquiring system, and/or payment network/system model may be compiled for example, into bundles, and after validation, may be placed in a production environment for use in processing transactions. In an exemplary embodiment, each element, whether it is an artifact, template, model, compiled bundle, or compiled runtime systems, may receive a version. As changes are made to the element, the version may be updated as necessary so as to manage the impacts on other elements. For example, an element such as a processing template may have a version associated therewith that may be stored, for example, in the MCR 215. The processing template may be used in a plurality of issuing system, acquiring system, and/or payment network/system models, each of which also has a version associated with it that may be stored in the MCR 215. The MCR 215 may store information identifying that the particular version of the template has been used in defining each of the particular versions of the issuing system, acquiring system, and/or payment network/system models. Similarly, when each of the issuing system, acquiring system, and/or payment network/system models is compiled, the corresponding production runtime version and each of the bundles comprised therein are assigned a version. Thereafter, when a change is made to the processing template, the MCR 215 may assign a new version to the changed template. The deployment manager 230 may query the MCR 215 to identify that the particular model has been updated with a new version and likewise identifies the issuing system, acquiring system, and/or payment network/system models that employ the updated template. The deployment manager 230 may compile at least the portion of the issuing system, acquiring system, and/or payment network/system model that may be affected by the change in the template and after testing and validation, creates a new runtime version of affected processing models. The deployment manager 230 may update the production version of the system in the platform runtime environment 255 with the new runtime version at a time when doing so will provide minimal disruption to the operation of the system.

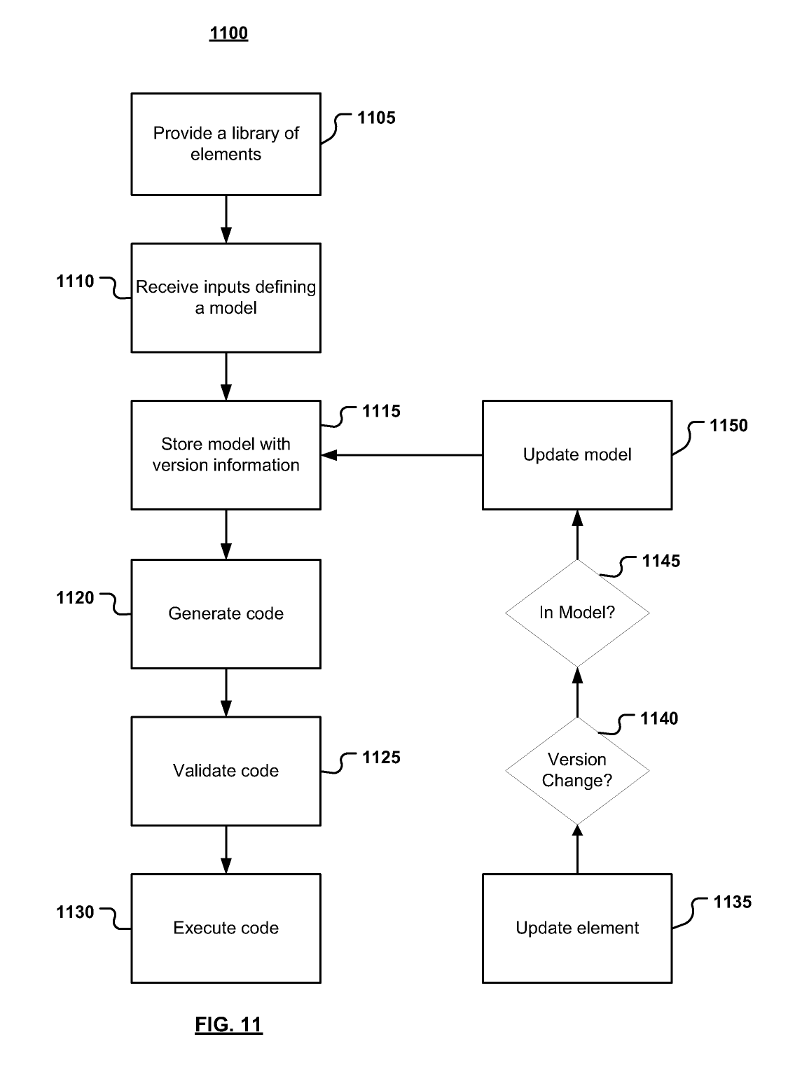

FIG. 11 depicts a flow diagram of an exemplary method for providing version management in an issuing system, an acquiring system, and/or a payment network/system. As shown in FIG. 11, at step 1105, a library of elements for use in defining an issuing system, an acquiring system, and/or a payment network/system may be provided. For example, elements such as artifacts and templates that may be stored in the IDE 210 and/or the MCR 215 may be made accessible to the development user 105 or an operator via the IDE 210. Each of the artifacts and templates may have an associated version that may be stored, for example, in the IDE 210 or MCR 215.

At step 1110, the MCR 215 may receive inputs selecting and arranging artifacts and templates into an issuing system, an acquiring system, and/or a payment network/system model. The inputs may be entered by, for example, the development user 105 or an operator of the IDE 210.

When the development user 105 or the operator has completed designing the model, at step 1115, the MCR 215 may store the model and information regarding the model including for example, the elements, e.g., artifacts and templates, comprised in the model. In particular, the MCR 215 may assign a version to the newly created model and stores that version information along with the version information for each of the elements that are comprised in the model.

At step 1120, object code may be created for the newly created issuing system, acquiring system, and/or payment network/system model. For example, the deployment manager 230 may compile the model into a format that may be executed.

At step 1125, the object code may be validated. For example, the deployment manager 230 may run the object code through a series of automated tests. Also, the deployment manager 230 may provide for the creator of the model to perform manual tests or specially designed automated tests on the object code. After the object code has been validated, at step 1130, the deployment manager 230 may place the validated object code into a runtime repository and, eventually, the validated object code may be placed into production and executed. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied.

After the issuing system, acquiring system, and/or payment network/system model is executing, in an example embodiment, an element such as an artifact or template that was included in the processing model (as well as other models that had previously or since been created) may be modified. For example, as shown at step 1135, a development user may use the IDE 210 to modify a template that may be used in a previously defined issuing system, acquiring system, and/or payment network/system. The MCR 215 may store the updated template and associates a new version number with the updated template.

At step 1140, the system may determine whether there has been any updates to elements used in creating processing models. For example, the deployment manager 230 may query the MCR 215 to determine whether there has been an update to a version of an element.

Upon identifying an updated element, at step 1145, the system identifies issuing system, acquiring system, and/or payment network/system models that may comprise the changed element. For example, the deployment manager 230 may query the MCR 215 to identify those models that comprise the element that has been updated, i.e. with the changed version. There may be, for example, a plurality of models that may have incorporated the modified element.

Upon identifying the processing models that employ the modified element, at step 1150, the system may update any of the models to reflect the updated element. For example, the MCR 215 may update the identified processing models to incorporate the updated element, i.e., the element with a new version.

As shown in FIG. 11, processing then returns to step 1115 where the updated models may be stored with new version information. The version information may identify a version for the model and comprise information identifying for each of the models the versions of the elements comprised in the model.

At steps 1120 through 1130, the code may be created from the updated models, validated, and executed as described above.

### Requirements Integration

According to an aspect of an exemplary embodiment, the system may provide for defining business requirements for an issuing system, an acquiring system, and/or a payment network/system. It is often the case in operating an issuing system, an acquiring system, and/or a payment network/system, that there are particular requirements that the designer of such systems and networks wishes the operating system to satisfy. For example, the issuing system, acquiring system, and/or payment network/system may be required to support various fund sources such as checking accounts, savings accounts, loan accounts, credit lines, or the like. A designer of the system may wish to define requirements for a user's interface with such fund sources. For example, the designer may specify the number or type of fund sources a user can have and/or use in the issuing system, acquiring system, and/or payment network/system. An exemplary embodiment provides for recording and management of such requirements.

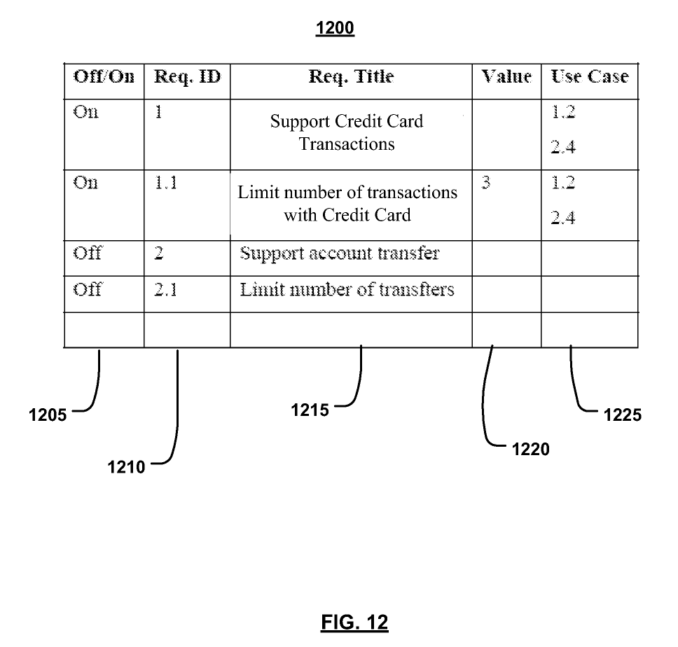

An exemplary system may provide an element or artifact that is used to specify and record requirements for the operation of an issuing system, an acquiring system, and/or a payment network/system. In an exemplary embodiment, the MCR 215 may include an element, such as an artifact, that may be used to document requirements of an issuing system, an acquiring system, and/or a payment network/system. An exemplary element may comprise a matrix that is adapted to document system requirements. For example, information corresponding to a matrix 1200 such as that depicted in FIG. 12 may be stored in the MCR 215 for access by users via the IDE 210. As shown in FIG. 12, an exemplary matrix may include a listing of requirements that have been designated for selection by the model designer. The designer may select using column 1205 that a particular requirement apply to the model. As shown, in the example of FIG. 12, the requirement designated in identification column 1210 as requirement 1 and titled in column 1215 as “Support Credit Card Transactions” has been selected in column 1205 as applying to the particular model. In the example, requirement 2 titled “Support ACH Transactions” has not been selected as designated in column 1205.

In an exemplary embodiment, the requirements may be nested such that if one requirement may be selected to be applied to the model, the development user or designer may also select further requirements related to previously selected requirement. For example, as illustrated in FIG. 12, if the requirement designated “1” is selected, the nested requirements 1.1 and 1.2 may be selected to be applied to the particular model.

In an exemplary embodiment, the requirements may be parameterized such that the designer may designate a value that is to be used in the model in connection with the corresponding requirement. As illustrated in FIG. 12, the matrix 1200 may include a column 1220 for receiving a parameter value corresponding to the particular requirement. For the particular example illustrated in FIG. 12, the requirement has been designated with the value of “3” indicating the issuing system, acquiring system, and/or payment network/system should allow for 3 fund sources. Additionally, in the illustration of FIG. 12, a particular value has been input. However, it should be noted that for other requirements, the development user or designer may specify another field or calculation which specifies the value of the parameter.

In an exemplary embodiment, the development user may designate that the requirement element be designated to apply to particular situations or for particular activities. For example, the requirement element may be designated to apply to particular workflows that potentially may be impacted by the selection. In the exemplary embodiment of FIG. 12, a separate column may be designated for specifying particular workflows to which the requirement applies. In particular, a use case column 1225 may be designated to specify particular use cases to which the requirement applies. Thus, the use case column links the requirement to the particular workflows that implement the requirement. This feature may allow the development user or designer to keep track of the aspects of the system that may be impacted by changes in the requirements of the system.

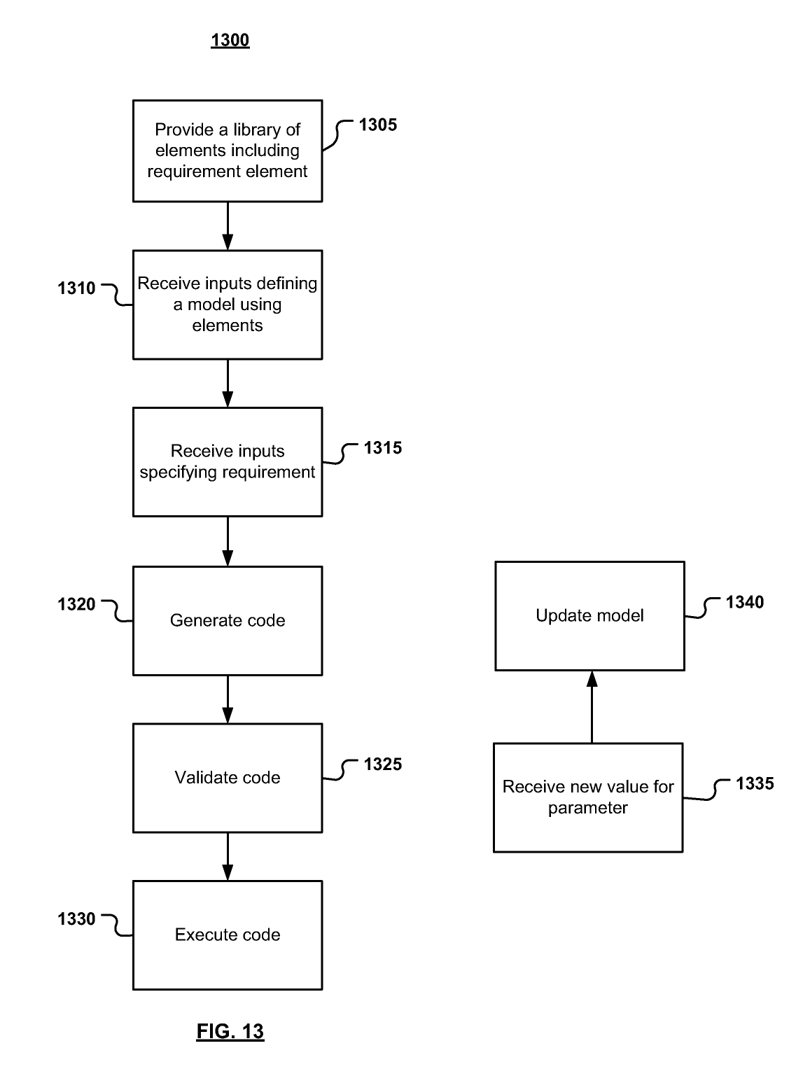

FIG. 13 depicts a flow diagram of exemplary processing for integrating business requirements into an issuing system, an acquiring system, and/or a payment network/system. As shown in FIG. 13, at step 1305, a library of elements for use in defining an issuing system, an acquiring system, and/or a payment network/system may be provided. For example, elements such as artifacts and templates that may be stored in the IDE 210 and/or the MCR 215 may be made accessible to the development user 105 or operators via the IDE 210. In particular, at step 1305, one or more elements for recording requirements to be applied in the system may be stored in the MCR 215 and made available to a user using the IDE 210. For example, an element such as the matrix discussed above in connection with FIG. 12 may be provided for recording requirements.

At step 1310, the IDE 210 and MCR 215 may receive inputs selecting and arranging artifacts and templates into an issuing system model, an acquiring system model and/or a payment network/system model. The inputs may be entered by, for example, a development user or an operator of the IDE 210. In the example of FIG. 13, at step 1310, inputs may be received specifying that an element for defining requirements for the system may be selected for use in connection with defining a model. In an exemplary embodiment, the selected element may be a requirements matrix such as described above in connection with FIG. 1200.

At step 1315, inputs may be received specifying the particular requirements that are to be associated with the selected requirements element. For example, the development user or designer of the system using the IDE 210 may select particular requirements to apply to the model. For example, in an embodiment wherein a matrix such as described in connection with FIG. 12 may be employed, the designer may select requirements for application to the model by selecting items in column 1205. Furthermore, at step 1315, the designer of the system may specify the parameter values for the particular requirement. In the exemplary embodiment of FIG. 12, the designer may specify in column 1220 the value of a parameter associated with particular requirements. Still further, in an exemplary embodiment, the designer may specify the uses to which the requirement should apply.

When the operator has completed designing the model, the MCR 215 may store the model and information regarding the model including for example, the elements, e.g. artifacts and templates, comprised in the model. In particular, the MCR 215 may store any requirement elements along with the remainder of the elements defining the model.

At step 1320, object code may be created for the newly created model. For example, the deployment manager 230 may compile the model into a format that may be executed. With respect to any requirement elements that have been defined, the requirements defined therein are applied to the various use cases as defined in the requirements element.

At step 1325, the object code may be validated. For example, the deployment manager 230 may run the object code through a series of automated tests. Also, the deployment manager 230 may provide for the creator of the model to test the object code. After the object code has been validated, at step 1330, the deployment manager 1330 may place the validated object code into a runtime repository and, eventually, the validated object code may be placed into production and executed. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied. While the system is being executed, the requirements as specified in the requirement element may be reflected in the operation of the system. For example, if a requirement element in a payment network/system model had specified that that the number of fund sources that can be linked to a user's account on the payment network/system should be limited to 3, the system in the runtime environment may enforce the requirement.

It will be appreciated that changes made to a requirements element after an issuing system model, an acquiring system model, and/or a payment network/system model has been placed in production may have the potential to impact portions of the issuing system model, the acquiring system model, and/or the payment network/system model that have been associated with the particular requirement. For example, if a value is changed for a requirement, the change in a requirement value may have an impact on the use cases that have been identified as related to the requirement. Therefore, as illustrated by steps 1335 and 1340, when a user changes the value of a requirement, use case information that may be stored in the requirements element may provide for manual and/or automatic modification of the model including any related use cases. In an illustrative scenario, the content, e.g., the workflows, that have been designated as implementing a requirement are marked as requiring review, whether it be manual or automated. Conversely, if a content item, e.g., workflow is changed, an exemplary embodiment may mark any requirements that have been associated with the workflow as requiring review.

### Service Level Agreement Integration

According to another aspect of an exemplary embodiment, a system may provide for integrating service level agreements/requirements into issuing system, acquiring system, and/or payment network/system models. The designer of an issuing system model, an acquiring system model, and/or a payment network/system model may wish to provide a particular level of service in an issuing system, an acquiring system, and/or a payment network/system. The desired level of service may be the result of, for example, contractual obligations that specify particular levels of service. For example, a provider of an issuing system, an acquiring system, and/or a payment network/system may be contractually obligated to encrypt account numbers associated with fund sources of a user when processing a transaction. As another example, there may be an expectation that responses from a third party vendor network would be received within 10 seconds of issuing a request to the third party network. An exemplary embodiment may provide for integrating elements corresponding to desired service levels into an issuing system model, an acquiring system model, and/or a payment network/system model. The service level agreements or requirements may often be associated with data flows that are defined in the model, wherein the service levels specify requirements for the operations within a data flow. Indeed, there may be many service level requirements integrated with the data flows that are comprised in a single model.

A compiled issuing system model, acquiring system model, and/or payment network/system model may include code for collecting data corresponding to each of the desired levels of service. During operation of an issuing system, an acquiring system, and/or a payment network/system, data corresponding to desired service levels may be collected by the issuing system, acquiring system, and/or payment network/system. The runtime analyzer 225 may analyze the collected data in real-time and may compare the collected data to the specified level of service. In an example embodiment, the runtime analyzer 225 may report on the operation of the system including, for example, reporting on whether the desired level service has not been, or is close to not being met. In an exemplary embodiment, the reporting may designate that requirements have not been met, or are close to not being met, and may provide suggestions for modifying the system so that the requirement is satisfied. In addition to generating reports regarding operation of the service, the runtime analyzer 225 may be configured to provide notification regarding the status of the desired levels of services. For example, the runtime analyzer 225 may communicate an alert when the desired level of service is not being met or is close to not being satisfied. The alert may be communicated in any useful manner including, for example, email and/or by providing a visual indication on the IDE 210. Emails may also be communicated via the switch center 250.

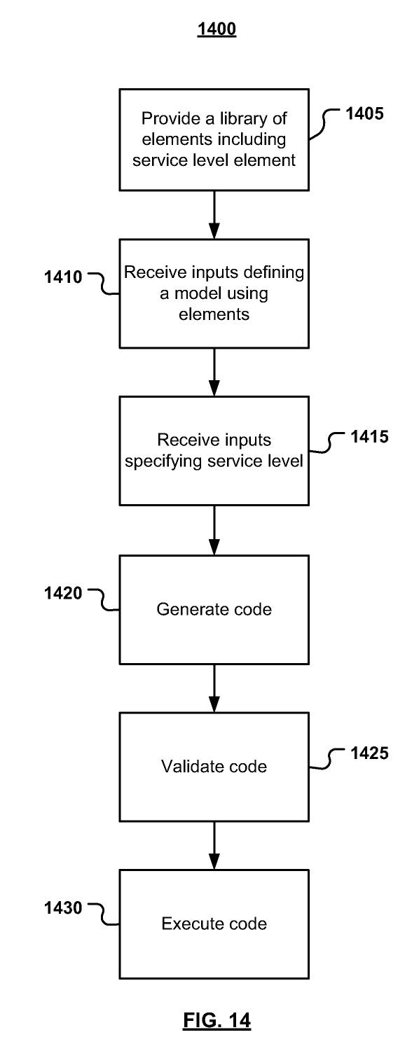

FIG. 14 depicts a flow diagram of exemplary processing for integrating service level agreements into an issuing system, an acquiring system, and/or a payment network/system. As shown in FIG. 14, at step 1405, a library of elements for use in defining a system may be provided. For example, elements such as artifacts and templates that may be stored in the MCR 215 may be made accessible to the development user 105 or an operator via the IDE 210. In particular, at step 1405, one or more elements for establishing and defining service level agreements may be stored in the MCR 215 and made available to a user using the IDE 210. In an exemplary embodiment, the elements for establishing and defining service level agreements may be artifacts that may be combined with data flows and other templates in an issuing system, an acquiring system, and/or a payment network/system model.

At step 1410, the MCR 215 may receive inputs selecting and arranging artifacts, data flow diagrams, and templates into a issuing system, acquiring system, and/or payment network/system model. The inputs may be entered by, for example, the development user 105 or an operator of the IDE 210. In the example of FIG. 14, at step 1410, inputs may be received specifying that an element for a desired service level may be selected for use in connection with defining a issuing system, acquiring system, and/or payment network/system model.

At step 1415, inputs may be received specifying details relating to the element for specifying the desired level of service. For example, where the service level relates to the average time to respond to requests for fund transfers, the development user or designer of the system may specify the threshold beyond which the response time may be unacceptable. The type of information that may be received may vary depending upon the particular service level requirement that is being defined. The development user or designer may use the IDE 210 to input the prescribed service level information. When the development user or operator has completed designing the model, the MCR 215 may store the model and information regarding the model including, for example, the elements, e.g. artifacts and templates, comprised in the model. In particular, artifacts defining desired levels of service may be stored in the MCR 215.

At step 1420, object code may be created for the newly created issuing system, acquiring system, and/or payment network/system model. For example, the deployment manager 230 may compile the model into a format that may be executed.

At step 1425, the object code may be validated. For example, the deployment manager 220 may run the object code through a series of automated tests. Also, the deployment manager 220 may provide for the creator of the model to test the object code. After the object code has been validated, at step 1430, the deployment manager may place the validated object code into a runtime repository and, eventually, the validated object code may be placed into production. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied.

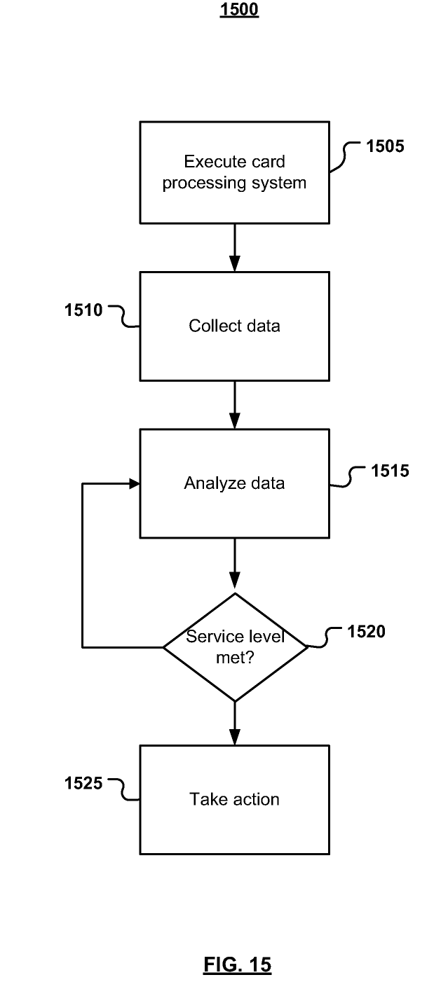

FIG. 15 depicts a flow diagram illustrating operation of an issuing system model, an acquiring system model, and/or a payment network/system model that has desired service levels specified therein. As shown, at step 1505, an issuing system, an acquiring system, and/or a payment network/system such as, for example, one created by the process of FIG. 14, may execute in the platform runtime environment 255.

At step 1510, the executing issuing system, acquiring system, and/or payment network/system may collect data regarding the operation of the system or network. In particular, the executing issuing system, acquiring system, and/or payment network/system may collect data regarding the service level operation of the system or network. For example, if during the design of the model the designer had specified a service level for the period of delay in responding to fund transfer requests, during execution the system or network may collect data relating to the time for responding to requests for fund transfers. The collected data may be stored in memory.

At step 1515, the runtime analyzer 225 may analyze the data that may be collected during execution of the issuing system, acquiring system, and/or payment network/system model. In particular, the runtime analyzer 225 may analyze the data relating to meeting the desired service level.

At step 1520, runtime analyzer 225 may determine whether the desired level of service is being met in the executing system. For example, the runtime analyzer 225 may determine whether the time for responding to requests for fund transfers satisfies the desired service level that was specified during modeling of the system. If the desired service level is being met, the runtime analyzer 225 may continue to monitor the data being collected by the executing system.

If, at step 1520, the runtime analyzer 225 may determine that the desired level of service has not been met, at step 1525, the runtime analyzer 225 may generate a report and provide notice that the requirement has not been met. For example, in one embodiment, the runtime analyzer 225 may send an email to the appropriate individuals and/or provide a notice via the IDE 210.

### Business Process Monitoring

According to another aspect of an exemplary embodiment, a system may provide for integrating process monitoring into issuing system, acquiring system, and/or payment network/system models. The designer of an issuing system model, an acquiring system model, and/or a payment network/system model may wish to monitor various activities during the operation of an executing issuing system, acquiring system, and/or a payment network/system. For example, the designer of an issuing system, an acquiring system, and/or a payment network/system may wish that the service periodically check that a file that is scheduled to be regularly forwarded has, in fact, been forwarded. Similarly, the designer may wish that the service periodically check that scheduled transaction clearances have, in fact, been received. In short, the designer may be interested in monitoring the operating system to determine that the desired events are happening rather than waiting for a problem to arise.

An exemplary embodiment may provide integrating elements corresponding to process monitoring into an issuing system, acquiring system, and/or payment network/system model. The process monitoring elements may be, for example, artifacts. The process monitoring elements may often be associated with data flows that may be defined in the model where the processing monitoring may be performed as an independent check to confirm that expected actions have been taken. Multiple process monitoring elements may be defined for a single workflow.

A compiled issuing system model, acquiring system model and/or payment network/system model includes code for collecting data corresponding to each of the process monitoring elements that is defined for a system. During operation of an issuing system, an acquiring system, and/or a payment network/system, data may be collected regarding operation of the system, and in particular, those portions for which monitoring elements exist. The runtime analyzer 225 may analyze the collected data in real-time and compare the collected data to the expected processing results as defined in the processing monitoring elements. In one embodiment, the runtime analyzer 225 may generate reports reflecting whether or not the processing monitoring elements have been met. In addition, the runtime analyzer 225 may be configured to provide notice regarding the status of the process monitoring. For example, the runtime analyzer 225 may communicate an alert when the processing data indicates the desired processing level is not being met or is close to not being satisfied. The alert may be communicated in any useful manner including, for example, email and/or by providing a visual indication on the IDE 210. Emails may also be communicated via the switch center 250.

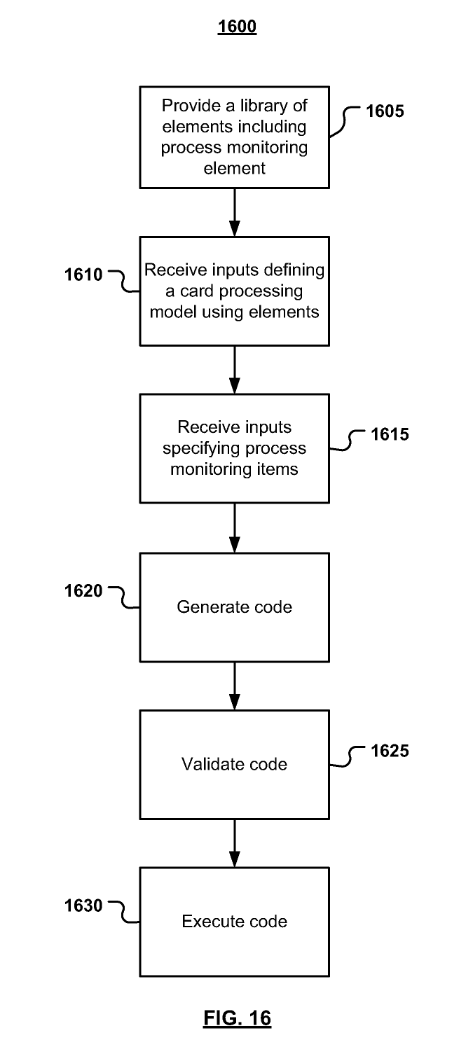

FIG. 16 depicts a flow diagram of an exemplary process for integrating process monitoring into an issuing system, an acquiring system, and/or a payment network/system. As shown in FIG. 16, at step 1605, a library of elements for use in defining an issuing system, an acquiring system and/or a payment network/system may be provided. For example, elements such as artifacts and templates that may be stored in the MCR 215 may be made accessible to the development users or operators via the IDE 210. In particular, at step 1605, one or more elements for establishing and defining process monitoring may be stored in the MCR 215 and made available to a user using the IDE 210. In an exemplary embodiment, the elements for establishing and defining process monitoring may be artifacts that may be combined with data flows and other templates in a processing model.

At step 1610, the MCR 215 may receive inputs selecting and arranging artifacts and templates into an issuing system model, an acquiring system model, and/or a payment network/system model. The inputs may be entered by, for example, the development user 105 or an operator of the IDE 210. In the example of FIG. 16, at step 1610, inputs may be received specifying that an element for a desired process monitoring may be selected for use in connection with defining an issuing system, an acquiring system, and/or a payment network/system model.

At step 1615, inputs may be received specifying details relating to the element for specifying the desired process monitoring. For example, where the process monitoring relates to whether an electronic file has been sent at the regularly scheduled time, the development user or designer of the system may specify the time by which the electronic file may be expected to have been sent. According to one embodiment, the development user or designer may use the IDE 210 to input the prescribed process monitoring information. When the development user or operator has completed designing the model, the MCR 215 may store the model and information regarding the model including, for example, the elements, e.g. artifacts and templates, comprised in the model. In particular, artifacts defining desired process monitoring may be stored in the MCR 215.

At step 1620, object code may be created for the newly created model. For example, the deployment manager 230 may compile the model into a format that may be executed.

At step 1625, the object code may be validated. For example, the deployment manager 230 may run the object code through a series of automated tests. Also, the deployment manager 230 may provide for the creator of the model to test the object code. After the object code has been validated, at step 1630, the deployment manager 230 may place the validated object code into a runtime repository and, eventually, the validated object code may be placed into production.

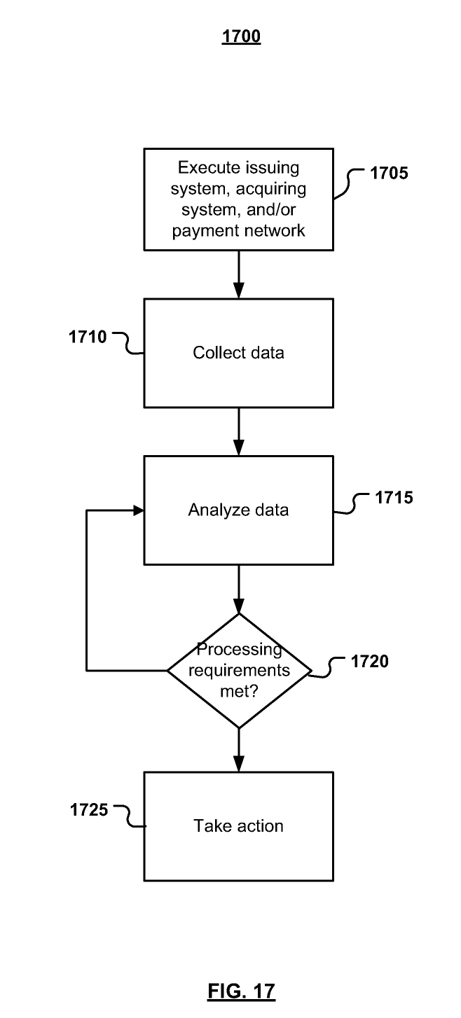

FIG. 17 depicts a flow diagram illustrating operation of an issuing system model, an acquiring system model, and/or a payment network or system model that has desired processing monitoring elements specified therein. As shown, at step 1705, an issuing system, an acquiring system, and/or a payment network/system such as, for example, one created by the process of FIG. 16, may be executed in the platform runtime environment 255. For example, the platform runtime environment may execute the code and thereby may become operable to manage issuing system, acquiring system, and/or payment network/system transactions, including, for example: receiving data about the creation and cancelation of financial accounts; interfacing with external systems to receive data about use of the financial accounts and/or instruments including payments made using and/or funds/credit made available to the financial accounts and/or instruments; interfacing with external systems such as banks and creditors regarding transactions completed using financial accounts and/or instruments; monitoring processing of transactions to determine whether design requirements, service level agreements, and desired processes are being satisfied; and interfacing with external systems to notify those systems regarding whether the established requirements and agreements are being satisfied.

At step 1710, the executing issuing system, acquiring system, and/or payment network/system may collect data regarding the operation of the system or network. In particular, the executing issuing system, acquiring system, and/or payment network/system may collect data relating to process monitoring elements that are defined in the system or network. For example, if during the design of the model the development user or designer had specified that process monitoring be used to check that an electronic file has been transmitted on a particular schedule, during execution the processing system may collect data relating to when the particular file is transmitted. The collected data may be stored in memory.

At step 1715, the process monitoring elements may analyze the data that may be collected during execution of the processing model. For example, if the processing monitoring elements have collected data regarding electronic transmission of an electronic file on a particular schedule, the processing monitoring elements may analyze the data to determine whether the schedule has been/is being satisfied.

At step 1720, the process monitoring elements may determine whether the events specified in the process monitoring element is being met in the executing system. For example, the process monitoring elements may determine whether the scheduled transmission of a file has taken place. If the expected processing has taken place, the process monitoring elements may continue to monitor the data being collected by the executing system.

If at step 1720 the process monitoring elements may determine that the desired level of service has not been met, at step 1725, the process monitoring elements may provide notice and/or perform an action. For example, in one embodiment, the monitoring elements may send an email to the appropriate individuals and/or provide a notice via the IDE 210.

### Platform as a Service

In an exemplary embodiment, access to the software and the environment for developing, testing, and executing issuing systems, acquiring systems, and payment networks/systems may be offered as a service. In other words, the development and runtime platform may be offered as a service. Thus, users may not need to own the software and hardware themselves, but may access the software and hardware platform that is provided by a service. Users may access a platform to selectively perform some or all of the activities needed to develop and operate an issuing system, an acquiring system, and/or a payment network/system. For example, users may access the software system to selectively develop an issuing system model, an acquiring system model, and/or a payment network/system model, to generate and test code for the model, and/or to place the model in production.

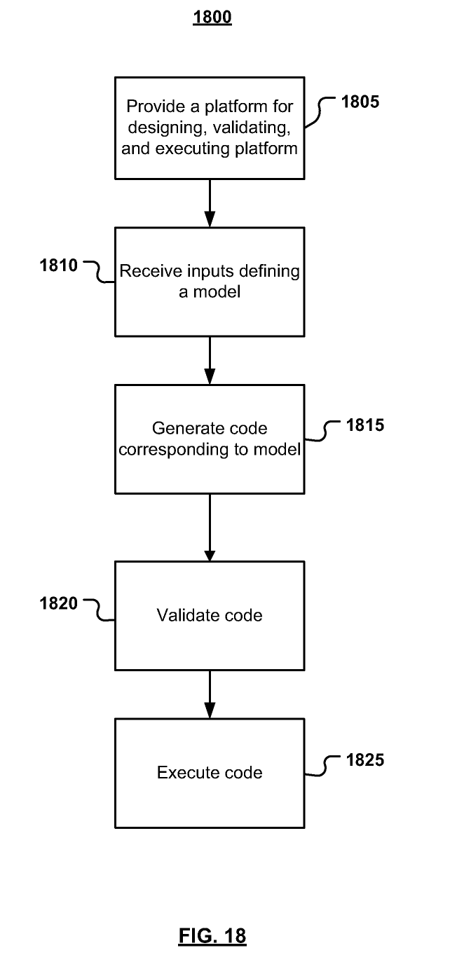

In an exemplary embodiment, the system described above in connection with, for example, FIGS. 1 through 3, may be made accessible as a service. A flow chart depicting the process of providing the issuing system, acquiring system, and/or payment network/system platform as a service is depicted in FIG. 18. As shown in FIG. 18, at step 1805, the platform may be made available to users for access. In other words, the software and the hardware for designing, validating, and operating issuing systems, acquiring systems, and/or payment networks/systems may be accessible to users. Thus, the MCR 215, IDE 210, deployment manager 230, and platform runtime environment 255 may be accessible to users. Referring to FIG. 1, the MCR 215, IDE 210, deployment manager 230, and platform runtime environment 255 may be located on model computing environment 120 and accessed by users with electronic devices 110 over communications network 115, which may comprise, for example, the Internet.

Referring again to FIG. 18, at step 1810, the service may receive inputs from users accessing software functionality for designing an issuing system model, an acquiring system model, and/or a payment network/system model. For example, users may access the IDE 210 from the platform and use the IDE 210 to access the MCR 215 to design a new model having issuing system, acquiring system, and/or payment network/system capabilities. The models that may be designed using the IDE 210 may be stored in the MCR 215.

At steps 1815 and 1820, the service may receive inputs from users to define the model and may generate object code corresponding to the model. The service, possibly using the deployment manager 230, may compile the model into an executable format and may perform a validation procedure such as testing.

At step 1825, the service may receive inputs from users requesting that the compiled code for the processing model be placed into production. The service may place the executable code in the platform runtime environment 255 to execute the model as described above.

In an illustrative embodiment, steps 1805 through 1825 may be performed at the service provider in response to user inputs received over a network. In this embodiment, the model content repository, the deployment manager, the platform runtime environment, and other portions of the platform may be operated and maintained by the service provider. Users may access the functionality via the integrated development environment using, for example, an electronic device, as described above.

In other illustrative embodiments, steps 1805 through 1825 may be performed at a combination of client and service provider locations. For example, in an illustrative embodiment, a client may access the service to design a model, compile the code, and validate the code as described above on the service provider's network. However, the runtime environment may exist on the client's machines and the executable code executed on the client machines. In such an embodiment, a runtime analyzer and deployment manager may likewise operate on the client machines. The division of functionality between the service provider's system may be customized to satisfy the needs of the client.

Illustrative Method for Issuing System, Acquiring System, and/or Payment Network/System Development

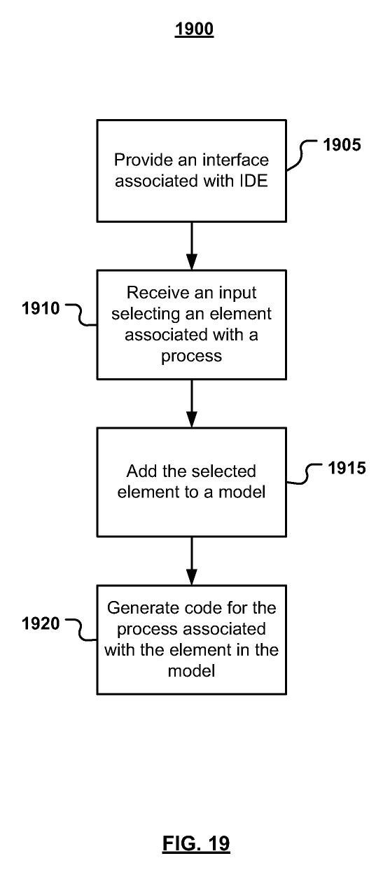

FIG. 19 depicts a flow diagram illustrating an exemplary process of developing an issuing system, an acquiring system, and/or a payment network/system. According to an example embodiment, a user such as the development user 105 may access an integrated development environment (IDE) such as the IDE 210 remotely from, for example, a web interface, a client interface, or the like to design and/or customize an issuing system, acquiring system, and/or payment network/system. For example, in one embodiment, the user may be a representative associated with an online community or a group that may wish to establish and/or customize an issuing system, acquiring system and/or payment network/system to handle payments and fund transfers between members in the community or group.

As shown in FIG. 19, at 1905, after accessing the IDE, an interface such as the interfaces shown in FIGS. 4-6 may be provided to the user that may include elements such as templates, data flow diagrams, artifacts, or the like.

The user may interact with the IDE to design and/or customize a model associated with an issuing system, an acquiring system, and/or a payment network/system using such elements. For example, the user may select a template, a data flow diagram, or the like from the IDE that the user wishes to be included in a model. Elements may include, for example, a template to add email notifications to an account holder when an account has been issued, templates to define or add an incentive program in a payment network or system, templates for Visa, MasterCard, and/or American Express message processing, templates for account-to-account transfers of funds, templates for load network integrations, templates for card embossing, encoding and fulfillment integrations, templates for identity verification to assist in managing card acquisition fraud, templates for defining cardholder and operator user interfaces, or any templates that may be used to define and customize an issuing system, an acquiring system, and/or a payment network/system. The elements may also include, for example, artifacts such as a plug-in module that may define a function of an issuing system, an acquiring system, and/or a payment network/system. The user may then drag and drop the template, data flow diagram, or the like into an editor window such as the editor 315 provided by the IDE. According to an example embodiment, the element such as the template, data flow diagram, or the like that may be dragged and dropped into the editor window may be received as an input at 1910 and added to the model at 1915.

According to example embodiments, after dragging and dropping the template, data flow diagram, or the like into the editor window and adding the template, data flow diagram, or the like to the model, the user may then define the parameters of the template, data flow diagram, or the like such that the model may be customized to fit within, for example, the business goals and/or operating constraints of the entity such as the online community or group for which the user may be establishing the issuing system, acquiring system, and/or payment network/system.

For example, the user may wish to add an incentive program for the payment network or system being developed. To add the incentive program, the user may select a template associated with an incentive program in a browser such as the model browser 305 or the artifact browser 310 and may drag the selected template to the editor that includes the model associated with the payment network/system being developed. The user may then define the parameters of selected template. For example, the user may enter a discount presentation that may be applied if a member, for example, uses a specific payment instrument within the network as a parameter to the selected template.

The user may continually select elements such as data flow diagrams, templates, artifacts, or the like until the model being designed by the user is complete. The user may then test the model, compile the code for the model, and deploy the model such that the model may be executed as a customized issuing system, acquiring system, and/or payment network/system. For example, in one embodiment, code for the processes associated with the elements of the model may be generated at 1920.

### Illustrative Computing Environment

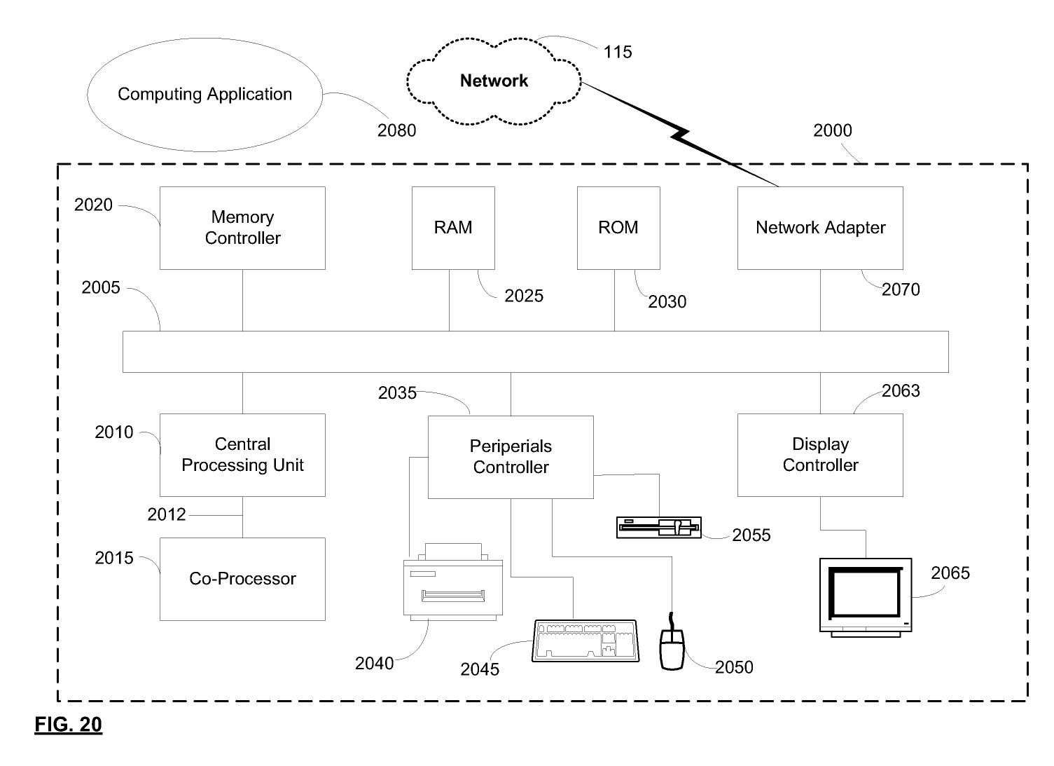

FIG. 20 depicts a block diagram of an exemplary computing system 1900 that may be used to implement the systems and methods described herein. For example, the computing system 100 may be used to implement the model computing environment 120, described above, as well as the IDE 210, the MCR 215, the platform runtime environment 255, or the like. The computing system 2000 may be capable of executing a variety of computing applications 2080. The computing applications 2080 may include a computing application, a computing applet, a computing program and other instruction set operative on the computing system 2000 to perform at least one function, operation, and/or procedure. According to an example embodiment, the computing applications may include the IDE 210 described above in FIGS. 2-3 and/or may be a system created using the IDE 210 and executing on the platform runtime environment 255. The computing system 2000 may be controlled primarily by computer readable instructions that may be in the form of software. The computer readable instructions may include instructions for the computing system 2000 for storing and accessing the computer readable instructions themselves. Such software may be executed within a central processing unit (CPU) 2010 to cause the computing system 2000 to perform the processes or functions associated therewith. In many known computer servers, workstations, personal computers, or the like, the CPU 2010 may be implemented by micro-electronic chips CPUs called microprocessors.

In operation, the CPU 2010 may fetch, decode, and/or execute instructions and may transfer information to and from other resources via a main data-transfer path or a system bus 2005. Such a system bus may connect the components in the computing system 2000 and may define the medium for data exchange. The computing system 2000 may further include memory devices coupled to the system bus 2005. According to an example embodiment, the memory devices may include a random access memory (RAM) 2025 and read only memory (ROM) 2030. The RAM 2025 and ROM 2030 may include circuitry that allows information to be stored and retrieved. In one embodiment, the ROM 130 may include stored data that cannot be modified. Additionally, data stored in the RAM 2025 typically may be read or changed by CPU 2010 or other hardware devices. Access to the RAM 2025 and/or ROM 2030 may be controlled by a memory controller 2020. The memory controller 2020 may provide an address translation function that translates virtual addresses into physical addresses as instructions are executed.

In addition, the computing system 2000 may include a peripherals controller 2035 that may be responsible for communicating instructions from the CPU 110 to peripherals, such as, a printer 2040, a keyboard 2045, a mouse 2050, and data a storage drive 2055. The computing system 2000 may further include a display 2065 that may be controlled by a display controller 2063. The display 2065 may be used to display visual output generated by the computing system 100. Such visual output may include text, graphics, animated graphics, video, or the like. The display controller 2063 may include electronic components that generate a video signal that may be sent to the display 2065. Further, the computing system 100 may include a network adaptor 2070 that may be used to connect the computing system 2000 to an external communication network such as the network 115, described above in FIG. 1.

Thus, applicants have disclosed exemplary embodiments of a system adapted for designing issuing system models, acquiring system models, and/or payment network/system models, generating code for issuing systems, acquiring systems, and/or payment networks/systems from the models, testing the code, and executing issuing systems, acquiring systems, and/or payment networks/systems. It will be appreciated that while illustrative embodiments have been disclosed, the scope of potential embodiments is not limited to those explicitly set out. For example, while the system has been described with reference to systems and methods for financial transaction processing, the envisioned embodiments extend beyond financial transactions.

The exemplary development environment offers a single source for designing and implementing issuing systems, acquiring systems and payment networks/systems. The disclosed environment offers entities the opportunity to use easily consumable tools in order to design and control payment systems.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method implemented in at least one computing system for developing an issuing system, acquiring system, or payment network or system, the method comprising:
providing elements associated with defined processes of an issuing system, acquiring system, or payment network or system;
receiving an input selecting one of the elements associated with the defined processes;
adding the selected one of the elements associated with the defined processes to a model defining an issuing system, acquiring system, or payment network or system; and
generating code corresponding to the processes associated with the selected one of the elements in the model.

2. The method of claim 1, wherein each of the elements associated with the defined processes has a corresponding flow diagram representation,
wherein receiving the input selecting one of the elements comprises receiving an input selecting a flow diagram representation, and
wherein adding the selected one of the elements to the model defining the issuing system, acquiring system or payment network or system comprises adding a selected flow diagram representation to a flow diagram of the model.

3. The method of claim 2, further comprising:
receiving information collected during execution of the generated code corresponding to the processes defined in the model;
rendering a visual indication of the information at an appropriate location in the flow diagram of the model.

4. The method of claim 1,
wherein providing the elements of defined processes of the issuing system, acquiring system or payment network or system comprises providing a library of predefined templates defining processing performed in connection with issuing systems, acquiring systems or payment networks or systems;
wherein receiving the input selecting one of the elements comprises receiving an input selecting one of the predefined templates;
wherein adding the selected one of the elements to the model defining the issuing system, acquiring system or payment network or system comprises adding the selected one of the predefined template to the model.

5. The method of claim 4, wherein the library of predefined templates comprises a template for performing communication with an electronic network for communicating credit, debit, and/or other payment transactions.

6. The method claim 5, wherein the electronic network for communicating credit, debit, and/or other payment transactions comprises a network for communicating transactions for at least one of the following transaction types: Visa; Mastercard; Discover; American Express; or any similar such network.

7. The method of claim 4, wherein the library of predefined templates comprises a template for performing interactive voice recognition.

8. A computer-readable storage medium comprising computer-executable instructions for developing an issuing system, acquiring system or payment network or system, wherein the computer-executable instructions when executed on a processor cause the processor to perform a method comprising:
providing elements associated with defined processes of an issuing system, acquiring system or payment network or system;
receiving an input selecting one of the elements associated with the defined processes;
adding the selected one of the elements associated with the defined processes to a model defining an issuing system, acquiring system or payment network or system; and
generating code corresponding to the processes associated with the selected one of the elements in the model.

9. A system adapted to develop an issuing system, acquiring system or payment network or system, comprising:
a processor; and
computing memory communicatively coupled with the processor, the computing memory having stored therein instructions for performing the following:
providing elements associated with defined processes of an issuing system, acquiring system or payment network or system;
receiving an input selecting one of the elements associated with the defined processes;
adding the selected one of the elements associated with the defined processes to a model defining an issuing system, acquiring system or payment network or system; and
generating code corresponding to the processes associated with the selected one of the elements in the model.

10. A method implemented in at least one computing system for developing an issuing system, acquiring system or payment network or system, the method comprising:
providing a computer model defining an issuing system, acquiring system or payment network or system, the computer model comprising a collection of predefined processes performed during processing of issuing system, acquiring system, or payment network or system transactions;
generating a software platform from the computer model; and
executing the code corresponding to the computer model.

11. The method of claim 8, further comprising:
communicating information collected while executing the code to the computer model; and
rendering a visual indication of the information at an appropriate location in the model.

12. A computer-readable storage medium comprising computer-executable instructions for developing an issuing system, acquiring system or payment network or system, wherein the computer-executable instructions when executed on a processor cause the processor to perform a method comprising:
providing a computer model defining an issuing system, acquiring system or payment network or system, the computer model comprising a collection of predefined processes performed during processing of issuing system, acquiring system, or payment network or system transactions;
generating a software platform from the computer model; and
executing the code corresponding to the computer model.

13. A system adapted to develop an issuing system, acquiring system or payment network or system, comprising:
a processor; and
computing memory communicatively coupled with the processor, the computing memory having stored therein instructions for performing the following:
providing a computer model defining an issuing system, acquiring system or payment network or system, the computer model comprising a collection of predefined processes performed during processing of issuing system, acquiring system, or payment network or system transactions;
generating a software platform from the computer model; and
executing the code corresponding to the computer model.

14. A method implemented in at least one computing system for developing an issuing system, acquiring system or payment network or system, comprising:
providing a plurality of artifacts, each artifact corresponding to a process for use in an issuing system, acquiring system or payment network or system; and
providing for each of the plurality of artifacts, software code for implementing the corresponding process; and
receiving a request to add one of the plurality of artifacts to a model defining an issuing system, acquiring system or payment network or system.

15. The method of claim 14, wherein providing a plurality of artifacts comprises providing at least one of the following: a workflow; a dataflow; an SLA; and a business process monitor.

16. The method of claim 14, further comprising:
generating code for the model to implement the model defining the issuing system, acquiring system or payment network or system including the one of the plurality of artifacts.

17. The method of claim 16, further comprising:
providing the generated code for the model to a platform, wherein the platform executes the code.

18. The method of claim 17, further comprising:
providing a visual representation of the model including the one of the plurality of artifacts defining the issuing system, acquiring system or payment network or system;
receiving information collected during execution of the generated code; and
rendering a visual indication of the information at an appropriate location in the visual representation of the model.

19. The method of claim 14, further comprising:
defining the plurality of artifacts;
defining the software code to implement each of the plurality of artifacts;
associating each of the artifacts with a portion of the software code; and
storing each of the plurality of artifacts with the associated software code in a library.

20. A computer-readable storage medium comprising computer-executable instructions for developing an issuing system, acquiring system or payment network or system, wherein the computer-executable instructions when executed on a processor cause the processor to perform a method comprising:
providing a plurality of artifacts, each artifact corresponding to a process for use in an issuing system, acquiring system or payment network or system; and
providing for each of the plurality of artifacts, software code for implementing the corresponding process; and
receiving a request to add one of the plurality of artifacts to a model defining an issuing system, acquiring system or payment network or system.

21. A system adapted to develop an issuing system, acquiring system or payment network or system, comprising:
a processor; and
computing memory communicatively coupled with the processor, the computing memory having stored therein instructions for performing the following:
providing a plurality of artifacts, each artifact corresponding to a process for use in an issuing system, acquiring system or payment network or system; and
providing for each of the plurality of artifacts, software code for implementing the corresponding process; and
receiving a request to add one of the plurality of artifacts to a model defining an issuing system, acquiring system or payment network or system.

22. A method implemented in at least one computing system for developing an issuing system, acquiring system or payment network or system, comprising:
defining a plurality of artifacts, each artifact corresponding to a process in an issuing system, acquiring system or payment network or system;
defining software code to implement each of plurality of artifacts;
associating each of the artifacts with a portion of the defined software code; and
storing each of the artifacts as elements in a library.

23. A computer-readable storage medium comprising computer-executable instructions for developing an issuing system, acquiring system or payment network or system, wherein the computer-executable instructions when executed on a processor cause the processor to perform a method comprising:
defining a plurality of artifacts, each artifact corresponding to a process in an issuing system, acquiring system or payment network or system;
defining software code to implement each of plurality of artifacts;
associating each of the artifacts with a portion of the defined software code; and
storing each of the artifacts in as elements in a library.

24. A system adapted to develop an issuing system, acquiring system or payment network or system, comprising:
a processor; and
computing memory communicatively coupled with the processor, the computing memory having stored therein instructions for performing the following:
defining a plurality of artifacts, each artifact corresponding to a process in an issuing system, acquiring system or payment network or system;
defining software code to implement each of plurality of artifacts;
associating each of the artifacts with a portion of the defined software code; and
storing each of the artifacts in as elements in a library.

25. A method implemented in at least one computing system for developing an issuing system, acquiring system or payment network or system, the method comprising:
providing a plurality of data flow diagrams, each of the data flow diagrams corresponding to processes that may be used in an issuing system, acquiring system or payment network or system;
receiving a first input selecting a first data flow diagram;
adding the first data flow diagram to a model defining an issuing system, acquiring system or payment network or system;
receiving a second input selecting a second data flow diagram;
adding the second data flow diagram to the model defining an issuing system, acquiring system or payment network or system; and
generating code corresponding to the model defining an issuing system, acquiring system or payment network or system.

26. The method of claim 25, further comprising:
providing the generated code for the model to a platform, wherein the platform executes the code.

27. The method of claim 26, further comprising:
providing a visual representation of the model defining an issuing system, acquiring system or payment network or system;
receiving information collected during execution of the generated code corresponding to the model; and
rendering a visual indication of the information at an appropriate location in the visual representation of the model.

28. The method of claim 25, further comprising:
defining the plurality of data flow diagrams;
defining software code to implement each of the plurality of data flow diagrams;
associating each of the data flow diagrams with a portion of the software code; and
storing each of the plurality of data flow diagrams with the associated software code in a library.

29. The method of claim 28, wherein the first data flow diagram and the second data flow diagram are selected from the library.

30. The method of claim 25, wherein receiving the input selecting the first data flow diagram comprises receiving at least one of the following: a first input of the first data flow diagram and a first output of the first data flow diagram.

31. The method of claim 30, wherein receiving the input selecting the second data flow diagram comprises receiving at least one of the following: a second input of the second data flow diagram and a second output of the first data flow diagram.

32. A computer-readable storage medium comprising computer-executable instructions for developing an issuing system, acquiring system or payment network or system, wherein the computer-executable instructions when executed on a processor cause the processor to perform a method comprising:
providing a plurality of data flow diagrams, each of the data flow diagrams corresponding to processes that may be used in an issuing system, acquiring system or payment network or system;
receiving a first input selecting a first data flow diagram;
adding the first data flow diagram to a model defining an issuing system, acquiring system or payment network or system;
receiving a second input selecting a second data flow diagram;
adding the second data flow diagram to the model defining an issuing system, acquiring system or payment network or system; and
generating code corresponding to the model defining an issuing system, acquiring system or payment network or system.

33. A system adapted to develop an issuing system, acquiring system or payment network or system, comprising:
a processor; and
computing memory communicatively coupled with the processor, the computing memory having stored therein instructions for performing the following:
providing a plurality of data flow diagrams, each of the data flow diagrams corresponding to processes that may be used in an issuing system, acquiring system or payment network or system;
receiving a first input selecting a first data flow diagram;
adding the first data flow diagram to a model defining an issuing system, acquiring system or payment network or system;
receiving a second input selecting a second data flow diagram;
adding the second data flow diagram to the model defining an issuing system, acquiring system or payment network or system; and
generating code corresponding to the model defining an issuing system, acquiring system or payment network or system.

34. A method of managing a model driven architecture system, comprising:
providing a plurality of elements for use in defining an issuing system, acquiring system or payment network or system;
creating a model defining an issuing system, acquiring system or payment network or system using one of the plurality of elements;
generating code corresponding to the model defining an issuing system, acquiring system or payment network or system;
receiving a change to the one of the plurality of elements;
creating an updated model defining the issuing system, acquiring system or payment network or system, the updated model reflecting the change to the one of the plurality of elements; and
generating updated code corresponding to the updated model defining the issuing system, acquiring system or payment network or system.

35. The method of claim 34, wherein the plurality of elements comprises at least one of the following: artifacts, flow diagrams, and templates.

36. The method of claim 34, wherein at least one of the plurality of elements comprises an artifact,
wherein creating the model defining the issuing system, acquiring system or payment network or system using one of the plurality of elements comprises selecting the artifact to add to the model.

37. The method of claim 36, wherein receiving the change to the one of the plurality of elements comprises receiving a change to the artifact, and wherein the updated model reflects the change to the artifact.

38. The method of claim 34, wherein at least one of the plurality of elements comprises a flow diagram,
wherein creating the model defining the issuing system, acquiring system or payment network or system using one of the plurality of elements comprises selecting the flow diagram to add to the model.

39. The method of claim 38, wherein receiving the change to the one of the plurality of elements comprises receiving a change to the flow diagram, and wherein the updated model reflects the change to the flow diagram.

40. The method of claim 34, wherein at least one of the plurality of elements comprises a template,
wherein creating the model defining the issuing system, acquiring system or payment network or system using one of the plurality of elements comprises selecting the template to add to the model.

41. The method of claim 34, wherein receiving the change to the one of the plurality of elements comprises receiving a change to the template, and wherein the updated model reflects the change to the template.

42. A computer-readable storage medium comprising computer-executable instructions for developing an issuing system, acquiring system or payment network or system, wherein the computer-executable instructions when executed on a processor cause the processor to perform a method comprising:
providing a plurality of elements for use in defining an issuing system, acquiring system or payment network or system;
creating a model defining an issuing system, acquiring system or payment network or system using one of the plurality of elements;
generating code corresponding to the model defining an issuing system, acquiring system or payment network or system;
receiving a change to the one of the plurality of elements;
creating an updated model defining the issuing system, acquiring system or payment network or system, the updated model reflecting the change to the one of the plurality of elements; and
generating updated code corresponding to the updated model defining the issuing system, acquiring system or payment network or system.

43. A method implemented in at least one computing system for providing an issuing system, acquiring system or payment network or system, comprising:
providing a plurality of elements for use in defining an issuing system, acquiring system or payment network or system, each of the plurality of elements having an associated version;
receiving inputs defining an issuing system, acquiring system, or payment network or system model using a set of the plurality of elements;
storing identification of the elements comprised in the model and for each of the elements comprised in the model storing identification of the version associated with the particular element.

44. The method of claim 43, further comprising compiling the model and executing the compiled model.

45. The method of claim 43, further comprising identifying an element has a changed associated version; and
identifying that the model comprises the element having a changed associated version.

46. The method of claim 45, further comprising:
updating the model to reflect the element having a changed associated version.

47. The method of claim 46, wherein updating the model to reflect the element having a changed associated version comprises validating that the updated model operates as desired.

48. The method of claim 47, wherein updating the model to reflect the element having a changed associated version comprises compiling the updated model and testing the compiled updated model.

49. The method of claim 43, wherein providing a plurality of elements for use in defining an issuing system, acquiring system or payment network or system comprises providing a plurality of templates and artifacts for use in defining an issuing system, acquiring system or payment network or system, each of the templates and artifacts having an associated version.

50. A computer-readable storage medium comprising computer-executable instructions for providing an issuing system, acquiring system or payment network or system, wherein the computer-executable instructions when executed on a processor cause the processor to perform a method comprising:
maintaining a database of a plurality of elements for use in defining an issuing system, acquiring system or payment network or system;
maintaining version information for each of the plurality of elements;
receiving inputs defining an issuing system, acquiring system, or payment network or system model using a set of the plurality of elements;
storing identification of the elements comprised in the model and for each the elements comprised in the model storing identification of the version associated with the element;
assigning a version to the model;
identifying that a new version has been created for an element in the set of plurality of elements; and
updating the issuing system, acquiring system, or payment network or system model with the new version of the element in the set of plurality of elements.

51. A system adapted to provide an issuing system, acquiring system or payment network or system, comprising:
a processor;
computing memory communicatively coupled with the processor, the computing memory having stored therein instructions for performing the following:
maintaining in memory information regarding a plurality of elements for use in defining an issuing system, acquiring system or payment network or system, each of the plurality of elements having an associated version;
receiving inputs defining an issuing system, acquiring system, or payment network or system model using a set of the plurality of elements;
storing identification of the elements comprised in the model and for each element comprised in the model storing identification of the version associated with the particular element;
identifying an element comprised in the model has a changed associated version; and
updating the model to reflect the element having a changed associated version.

52. A method implemented in at least one computing system for providing an issuing system, acquiring system or payment network or system, comprising:
providing a plurality of elements for use in defining an issuing system, acquiring system or payment network or system, at least one of the plurality of elements representing a parameter for use in operation of an issuing system, acquiring system or payment network or system;
receiving inputs defining a model for an issuing system, acquiring system or payment network or system using the plurality of elements, the model comprising the at least one of the plurality of elements representing a parameter for use in operation of an issuing system, acquiring system or payment network or system;
receiving a value for the at least one of the plurality of elements representing a parameter for use in operation of an issuing system, acquiring system or payment network or system; and
generating code from the model for an issuing system, acquiring system or payment network or system, at least portion of the code dependent upon the value for the at least one of the plurality of elements representing a parameter.

53. The method of claim 52, wherein receiving inputs defining a model for an issuing system, acquiring system or payment network or system using the plurality of elements comprises receiving inputs defining data flows, at least a portion of the data flows dependent upon the at least one of the plurality of elements representing a parameter.

54. The method of claim 52, further comprising executing the code.

55. The method of claim 52, further comprising receiving an updated value for the at least one of the plurality of elements representing a parameter.

56. The method of claim 55, further comprising regenerating code from the model for an issuing system, acquiring system or payment network or system, at least a portion of the code reflecting the updated value for the at least one of the plurality of elements representing a parameter for use in operation of an issuing system, acquiring system or payment network or system.

57. The method of claim 52, wherein the at least one of the plurality of elements representing a parameter for use in operation of an issuing system, acquiring system or payment network or system comprises a list of selectable parameters, each selectable parameters being selectable to designate a parameter as applicable to an issuing system, acquiring system or payment network or system.

58. The method of claim 57, further wherein the list of selectable parameters is adapted to receive a value corresponding to a selectable parameter.

59. The method of claim 52, wherein the at least one of the plurality of elements representing a parameter for use in operation of an issuing system, acquiring system or payment network or system comprises a matrix of selectable parameters.

60. The method of claim 52 wherein the at least one of the plurality of elements representing a parameter for use in operation of an issuing system, acquiring system or payment network or system comprises an element representing a business parameter for use in operation of an issuing system, acquiring system or payment network or system.

61. A computer-readable storage medium comprising computer-executable instructions for providing an issuing system, acquiring system or payment network or system, wherein the computer-executable instructions when executed on a processor cause the processor to perform a method comprising:
maintaining a database of a plurality of elements for use in defining an issuing system, acquiring system or payment network or system, at least one of the plurality of elements representing a parameter for use in operation of an issuing system, acquiring system or payment network or system;
receiving inputs defining a model for an issuing system, acquiring system or payment network or system using the plurality of elements, the model comprising the at least one of the plurality of elements representing a parameter for use in operation of an issuing system, acquiring system or payment network or system;
receiving a value for the at least one of the plurality of elements representing a parameter for use in operation of an issuing system, acquiring system or payment network or system; and
generating code from the model for an issuing system, acquiring system or payment network or system, at least portion of the code dependent upon the value for the at least one of the plurality of elements representing a parameter.

62. A system adapted to provide an issuing system, acquiring system or payment network or system, comprising:
a processor;
computing memory communicatively coupled with the processor, the computing memory having stored therein instructions for performing the following:
maintaining in memory a plurality of elements for use in defining an issuing system, acquiring system or payment network or system, at least one of the plurality of elements representing a parameter for use in operation of an issuing system, acquiring system or payment network or system;
receiving inputs defining a model for an issuing system, acquiring system or payment network or system using the plurality of elements, the model comprising the at least one of the plurality of elements representing a parameter for use in operation of an issuing system, acquiring system or payment network or system;
receiving a value for the at least one of the plurality of elements representing a parameter for use in operation of an issuing system, acquiring system or payment network or system; and
generating code from the model for an issuing system, acquiring system or payment network or system, at least a portion of the code dependent upon the value for the at least one of the plurality of elements representing a parameter.

63. A method implemented in at least one computing system for providing an issuing system, acquiring system or payment network or system, comprising:
providing a plurality of elements for use in defining an issuing system, acquiring system or payment network or system, at least one of the plurality of elements representing a desired service level for operation of an issuing system, acquiring system or payment network or system;
receiving inputs defining a model for an issuing system, acquiring system or payment network or system using the plurality of elements, the model comprising the at least one of the plurality of elements representing a desired service level for operation of an issuing system, acquiring system or payment network or system; and
generating code from the model for an issuing system, acquiring system or payment network or system, at least a portion of the code adapted to identify that the desired service level has not been satisfied.

64. The method of claim 63, further comprising executing the code, wherein executing code comprises identifying that the desired service level has not been satisfied.

65. The method of claim 63, further comprising executing the code, wherein executing the code comprises identifying that the desired service level has not been satisfied and in response taking an action.

66. The method of claim 63, wherein taking an action comprises communicating an alert.

67. The method of claim 63, wherein taking an action comprises modifying the operation of the issuing system, acquiring system or payment network or system.

68. The method of claim 63, wherein the at least one of the plurality of elements representing a desired service level for operation of an issuing system, acquiring system or payment network or system defines a level of timeliness.

69. A computer-readable storage medium comprising computer-executable instructions for providing an issuing system, acquiring system or payment network or system, wherein the computer-executable instructions when executed on a processor cause the processor to perform a method comprising:
maintaining a storage comprising a plurality of elements for use in defining an issuing system, acquiring system or payment network or system, at least one of the plurality of elements representing a desired service level for operation of an issuing system, acquiring system or payment network or system;
receiving inputs defining a model for an issuing system, acquiring system or payment network or system using the plurality of elements, the model comprising the at least one of the plurality of elements representing a desired service level for operation of an issuing system, acquiring system or payment network or system; and
generating code from the model for an issuing system, acquiring system or payment network or system, at least a portion of the code adapted to identify that the desired service level has not been satisfied.

70. A system for providing issuing systems, acquiring systems, or payment networks or systems, comprising:
a processor;
computing memory communicatively coupled with the processor, the computing memory having stored therein instructions for performing the following:
maintaining a storage comprising a plurality of elements for use in defining an issuing system, acquiring system or payment network or system, at least one of the plurality of elements representing a desired service level for operation of an issuing system, acquiring system or payment network or system;
receiving inputs defining a model for an issuing system, acquiring system or payment network or system using the plurality of elements, the model comprising the at least one of the plurality of elements representing a desired service level for operation of an issuing system, acquiring system or payment network or system; and
generating code from the model for an issuing system, acquiring system or payment network or system, at least a portion of the code adapted to identify that the desired service level has not been satisfied.

71. A method implemented in at least one computing system for providing an issuing system, acquiring system or payment network or system, comprising:
executing an issuing system, acquiring system or payment network or system;
identifying that a desired service level for the issuing system, acquiring system or payment network or system has not been satisfied;
in response to identifying that a desired service level has not been satisfied, automatically generating a response.

72. The method of claim 71, wherein identifying that a desired service level has not been satisfied comprises collecting data relating to the desired level of service during execution of the issuing system, acquiring system or payment network or system.

73. The method of claim 71, wherein identifying that a desired service level has not been satisfied further comprises analyzing the collected data.

74. The method of claim 71, wherein identifying that a desired service level has not been satisfied comprises checking for the existence of a file.

75. The method of claim 71, wherein identifying that a desired service level has not been satisfied comprises reviewing the contents of a file.

76. The method of claim 71, wherein identifying that a desired service level has not been satisfied comprises identifying that a defined level of timeliness has not been satisfied.

77. The method of claim 71, wherein automatically generating a response comprises issuing an alert.

78. The method of claim 71, wherein automatically generating a response comprises causing a change in the operation of the issuing system, acquiring system or payment network or system.

79. A computer-readable storage medium comprising computer-executable instructions for providing an issuing system, acquiring system or payment network or system, wherein the computer-executable instructions when executed on a processor cause the processor to perform a method comprising:
executing an issuing system, acquiring system or payment network or system;
identifying that a desired service level for the issuing system, acquiring system or payment network or system has not been satisfied;
in response to identifying that a desired service level has not been satisfied, automatically generating response.

80. A system for providing an issuing system, acquiring system or payment network or system, the system comprising:
a processor;
computing memory communicatively coupled with the processor, the computing memory having stored therein instructions for performing the following:
executing an issuing system, acquiring system or payment network or system;
identifying that a desired service level for the issuing system, acquiring system or payment network or system has not been satisfied;
in response to identifying that a desired service level has not been satisfied, automatically generating a response.

81. A method implemented in at least one computing system for providing an issuing system, acquiring system or payment network or system, comprising:
providing a plurality of elements for use in defining an issuing system, acquiring system or payment network or system, at least one of the plurality of elements representing a process monitoring requirement for operation of an issuing system, acquiring system or payment network or system;
receiving inputs defining a model for an issuing system, acquiring system or payment network or system using the plurality of elements, the model comprising the at least one of the plurality of elements representing a process monitoring requirement for operation of an issuing system, acquiring system or payment network or system; and
generating code from the model for an issuing system, acquiring system or payment network or system, at least a portion of the code adapted to identify that the process monitoring requirement has not been satisfied.

82. The method of claim 81, further comprising executing the code, wherein executing code comprises identifying that the process monitoring requirement has not been satisfied.

83. The method of claim 81, further comprising executing the code, wherein executing the code comprises identifying that the process monitoring requirement has not been satisfied and in response taking an action.

84. The method of claim 81, wherein taking an action comprises issuing an alert.

85. The method of claim 81, wherein taking an action comprises modifying the operation of the issuing system, acquiring system or payment network or system.

86. The method of claim 81, wherein the at least one of the plurality of elements representing a process monitoring requirement defines a level of timeliness.

87. A computer-readable storage medium comprising computer-executable instructions for providing an issuing system, acquiring system or payment network or system, wherein the computer-executable instructions when executed on a processor cause the processor to perform a method comprising:
providing a plurality of elements for use in defining an issuing system, acquiring system or payment network or system, at least one of the plurality of elements representing a process monitoring requirement for operation of an issuing system, acquiring system or payment network or system;
receiving inputs defining a model for an issuing system, acquiring system or payment network or system using the plurality of elements, the model comprising the at least one of the plurality of elements representing a process monitoring requirement for operation of an issuing system, acquiring system or payment network or system; and
generating code from the model for an issuing system, acquiring system or payment network or system, at least a portion of the code adapted to identify that the process monitoring requirement has not been satisfied.

88. A system adapted to provide an issuing system, acquiring system or payment network or system, comprising:
a processor;
computing memory communicatively coupled with the processor, the computing memory having stored therein instructions for performing the following:
providing a plurality of elements for use in defining an issuing system, acquiring system or payment network or system, at least one of the plurality of elements representing a process monitoring requirement for operation of an issuing system, acquiring system or payment network or system;
receiving inputs defining a model for an issuing system, acquiring system or payment network or system using the plurality of elements, the model comprising the at least one of the plurality of elements representing a process monitoring requirement for operation of an issuing system, acquiring system or payment network or system; and
generating code from the model for an issuing system, acquiring system or payment network or system, at least a portion of the code adapted to identify that the process monitoring requirement has not been satisfied.

89. A method implemented in at least one computing system for providing an issuing system, acquiring system or payment network or system, comprising:
executing code for an issuing system, acquiring system or payment network or system;
identifying that a process monitoring requirement has not been satisfied;
in response to identifying that a process monitoring requirement has not been satisfied, automatically generating response.

90. The method of claim 89, wherein identifying that a process monitoring requirement has not been satisfied comprises identifying that a defined level of timeliness has not been satisfied.

91. The method of claim 89, wherein automatically generating a response comprises issuing an alert.

92. The method of claim 89, wherein automatically generating a response comprises causing a change in the operation issuing system, acquiring system or payment network or system.

93. A computer-readable storage medium comprising computer-executable instructions for providing an issuing system, acquiring system or payment network or system, wherein the computer-executable instructions when executed on a processor cause the processor to perform a method comprising:
executing code for an issuing system, acquiring system or payment network or system;
identifying that a process monitoring requirement has not been satisfied; and
in response to identifying that a process monitoring requirement has not been satisfied, automatically generating response.

94. A system adapted to provide an issuing system, acquiring system or payment network or system, comprising:
a processor; and
computing memory communicatively coupled with the processor, the computing memory having stored therein instructions for performing the following:
executing code for an issuing system, acquiring system or payment network or system;
identifying that a process monitoring requirement has not been satisfied;
in response to identifying that a process monitoring requirement has not been satisfied, automatically generating response.

95. A method for providing an issuing system, acquiring system or payment network or system, comprising:
at a service provider, providing access to a development system for developing an issuing system, acquiring system, or payment network or system, the development system for developing the issuing system, acquiring system, or payment network or system adapted to receive inputs for designing a model for an issuing system, acquiring system or payment network or system, generate code for implementing the model, and execute the code;
at the service provider, receiving inputs interfacing with the development system for developing an issuing system, acquiring system, or payment network or system to design a model for providing an issuing system, acquiring system or payment network or system;
at the service provider, in response inputs received at the development system for developing an issuing system, acquiring system, or payment network or system, generating code corresponding to the model for providing an issuing system, acquiring system or payment network or system; and
at the service provider, in response to inputs received at the development system for developing an issuing system, acquiring system, or payment network or system, executing the code corresponding to the model for providing an issuing system, acquiring system or payment network or system.

96. The method of claim 95, wherein providing access to a development system for developing an issuing system, acquiring system, or payment network or system comprises providing access to the system over a communications network.

97. The method of claim 95, wherein providing access to a development system for developing an issuing system, acquiring system, or payment network or system comprises providing access to a system comprising:
a repository of elements for use in specifying a issuing system, acquiring system, or payment network or system model;
a development environment application adapted to access the repository of elements, receive inputs establishing an issuing system, acquiring system, or payment network or system model using the elements, and store the model in the repository.

98. The method of claim 97, wherein receiving inputs interfacing with the development system for developing an issuing system, acquiring system, or payment network or system to design a model comprises receiving inputs interfacing with the development environment application to define a issuing system, acquiring system, or payment network or system model.

99. The method of claim 95, wherein providing access to a development system for developing an issuing system, acquiring system, or payment network or system comprises providing access to a system comprising:
a deployment manager adapted to compile issuing system, acquiring system, or payment network or system models and validate operation of code.

100. The method of claim 99, wherein generating code corresponding to the model for providing an issuing system, acquiring system or payment network or system comprises operating the deployment manager to compile the model for providing an issuing system, acquiring system or payment network or system and to perform validation of the compiled model.

101. The method of claim 95, wherein providing access to a development system for developing an issuing system, acquiring system, or payment network or system comprises providing access to a system comprising:
a platform runtime environment adapted to execute code for issuing systems, acquiring systems or payment networks or systems.

102. The method of claim 101, wherein executing the code corresponding to the model for providing an issuing system, acquiring system or payment network or system comprises executing the code corresponding to the model in the platform runtime environment.

103. A method for providing an issuing system, acquiring system or payment network or system, comprising:
at a service provider, providing access to a development system for developing an issuing system, acquiring system, or payment network or system, the development system for developing the issuing system, acquiring system, or payment network or system adapted to receive inputs for designing a model for an issuing system, acquiring system or payment network or system, generate code for implementing the model, and execute the code;
at the service provider, receiving inputs interfacing with the development system for developing an issuing system, acquiring system, or payment network or system to design a model for providing an issuing system, acquiring system or payment network or system;
at the service provider, in response inputs received at the development system for developing an issuing system, acquiring system, or payment network or system, generating code corresponding to the model for providing an issuing system, acquiring system or payment network or system; and
at the service user, in response to inputs received at the development system for developing an issuing system, acquiring system, or payment network or system, executing the code corresponding to the model for providing an issuing system, acquiring system or payment network or system.

104. A method for providing an issuing system, acquiring system or payment network or system, comprising:
at a service provider, providing access to a development system for developing an issuing system, acquiring system, or payment network or system, the development system for developing the issuing system, acquiring system, or payment network or system adapted to receive inputs for designing a model for an issuing system, acquiring system or payment network or system, generate code for implementing the model, and execute the code;
at the service provider, receiving inputs interfacing with the development system for developing an issuing system, acquiring system, or payment network or system to design a model for providing an issuing system, acquiring system or payment network or system;
at the service user, in response inputs received at the development system for developing an issuing system, acquiring system, or payment network or system, generating code corresponding to the model for providing an issuing system, acquiring system or payment network or system; and
at the service user, in response to inputs received at the development system for developing an issuing system, acquiring system, or payment network or system, executing the code corresponding to the model for providing an issuing system, acquiring system or payment network or system.

105. A method implemented in at least one computing system for developing an issuing system, acquiring system or payment network or system, the method comprising:
providing an interface associated with an integrated development environment, wherein the interface comprises elements associated with defined processes of the issuing system, acquiring system, or payment network or system;
receiving an input selecting one of the elements associated with the defined processes of the issuing system, acquiring system or payment network or system;
adding the selected element associated with the defined processes to a model defining the issuing system, acquiring system or payment network or system; and
generating code corresponding to the processes associated with the selected element in the model.

106. The method of claim 105, further comprising receiving a parameter defining the selected element in the model.

107. The method of claim 106, wherein the parameter comprises an operating constraint of an entity for which the issuing system, acquiring system or payment network or system is being established.

108. The method of claim 107, wherein the operating constraint comprises a limit on a particular account approved to be used in the issuing system, acquiring system or payment network or system.

109. The method of claim 105, wherein the elements of defined processes of the issuing system, acquiring system or payment network or system comprises a library of predefined templates defining processing performed in connection with the issuing system, acquiring system or payment network or system.

110. The method of claim 109, wherein receiving the input selecting one of the elements comprises receiving an input selecting one of the predefined templates, and wherein adding the selected element to the model defining the issuing system, acquiring system, or the payment network or system comprises adding the selected predefined template to the model.

111. The method of claim 109, wherein the library of predefined templates comprises a template for an incentive program of a payment network or system.

112. A computer-readable storage medium comprising computer-executable instructions for developing an issuing system, acquiring system or payment network or system, wherein the computer-executable instructions when executed on a processor cause the processor to perform a method comprising:
providing an interface associated with an integrated development environment, wherein the interface comprises elements associated with defined processes of the issuing system, acquiring system, or payment network or system;
receiving an input selecting one of the elements associated with the defined processes of the issuing system, acquiring system or payment network or system;
adding the selected element associated with the defined processes to a model defining the issuing system, acquiring system or payment network or system; and
generating code corresponding to the processes associated with the selected element in the model.

113. A system adapted to develop an issuing system, acquiring system or payment network or system, comprising:
a processor; and
computing memory communicatively coupled with the processor, the computing memory having stored therein instructions for performing the following:
providing an interface associated with an integrated development environment, wherein the interface comprises elements associated with defined processes of the issuing system, acquiring system, or payment network or system;
receiving an input selecting one of the elements associated with the defined processes of the issuing system, acquiring system or payment network or system;
adding the selected element associated with the defined processes to a model defining the issuing system, acquiring system or payment network or system; and
generating code corresponding to the processes associated with the selected element in the model.
